(19) United States
(12) Patent Application Publication
(10) Pub. No.: US 2013/0151023 A1
(43) Pub. Date: Jun. 13, 2013

(54) LIBRARY DEVICE, METHOD FOR CONTROLLING LIBRARY DEVICE, AND RECORDING MEDIUM FOR LIBRARY DEVICE CONTROL PROGRAM

(71) Applicant: Fujitsu Limited, Kawasaki-shi (JP)

(72) Inventor: Yukio Taniyama, Yokohama (JP)

(73) Assignee: FUJITSU LIMITED, Kawasaki-shi (JP)

(21) Appl. No.: 13/666,279

(22) Filed: Nov. 1, 2012

(30) Foreign Application Priority Data
Dec. 12, 2011 (JP) 2011-271430

(51) Int. Cl. G05F 5/00

(52) U.S. Cl. 700/291

(57) ABSTRACT

A library device having a plurality of processing units that control data access to one or more drive units includes a processor and a memory coupled to the processor. The processor executes collecting state information of each drive unit processed in each of the processing units, predicting a number of drive units in use a certain amount of time later, based on the state information of each drive unit in the processing units, predicting a number of the processing units in demand a certain amount of time later, based on restricting information that indicates the number of the drive units to be controlled by the processing unit and the number of the drive units that has been predicted, and controlling supply of electric power to the processing units, based on the number of the processing units in demand predicted by the predicting of the number of the processing units.

### CROSS-REFERENCE TO RELATED APPLICATION

This application is based upon and claims the benefit of priority of the prior Japanese Patent Application No. 2011-271430, filed on Dec. 12, 2011, the entire contents of which are incorporated herein by reference.

### FIELD

The embodiment discussed herein is related to a library device, a method for controlling a library device, and a recording medium for a library device control program.

### BACKGROUND

A physical tape library device is used for data backup in a server system for example, and so forth. This physical tape library device has multiple physical tape drive devices, multiple tape cartridges, transporting robot devices, and so forth. While the physical tape library device uses a great number of physical tape drive devices when operating under a heavy load, only a part of the physical tape drive devices are used when the load is light and the power to the physical tape drive devices not being used is manually switched off, so as to reduce power consumption for operation.

Also, in recent years, there is a virtual tape library device, for example, used for data back up in a server system, and so forth, as described in Japanese Laid-open Patent Publication No. 2003-58326.

A virtual tape library device is a system where tape drive devices and cartridge tapes are virtualized on a dedicated disk device, and is realizes as a tape device from the server OS (Operating System). The server can use this virtualized tape (virtual tape) in the same way as with a normal tape device, and accordingly, the server can use the virtual tape library device in the same way as if actual tapes were mounted thereto.

Specifically, a virtual tape library device has multiple data processing units, and realizes functions equivalent to those of a physical tape library device by virtually emulating (reconstructing) the multiple tape drive devices and the multiple tape cartridge transporting devices.

Even with such a virtual tape library device, there is demand to reduce power consumption and realize efficient operations, but with a virtual tape library device, manually separating the individual data processing units and turning the power thereto on/off is complicated and troublesome.

### SUMMARY

According to an aspect of the invention, a library device having a plurality of processing units that control data access to one or more drive units, the library device includes a processor and a memory coupled to the processor. The processor executes collecting state information of each drive unit processed in each of the processing units, predicting a number of drive units in use a certain amount of time later, based on the state information of each drive unit in the processing units collected by the collecting, predicting a number of the processing units in demand a certain amount of time later, based on restricting information that indicates the number of the drive units to be controlled by the processing unit and the number of the drive units that has been predicted, and controlling supply of electric power to the processing units, based on the number of the processing units in demand predicted by the predicting of the number of the processing units.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating the configuration of a virtual tape system as an example of an embodiment.

FIG. 2 is a diagram exemplarily illustrating processing unit state information in a virtual tape system as an example of an embodiment.

FIG. 3 is a diagram exemplarily illustrating logical drive usage prediction information in a virtual tape system as an example of an embodiment.

FIG. 4 is a diagram exemplarily illustrating logical drive usage prediction information in a virtual tape system as an example of an embodiment.

FIG. 5 is a diagram exemplarily illustrating physical drive usage prediction information in a virtual tape system as an example of an embodiment.

FIG. 6 is a diagram exemplarily illustrating physical drive usage prediction information in a virtual tape system as an example of an embodiment.

FIG. 7 is a diagram exemplarily illustrating ICP configuration change threshold information in a virtual tape system as an example of an embodiment.

FIG. 8 is a diagram exemplarily illustrating IDP configuration change threshold information in a virtual tape system as an example of an embodiment.

FIG. 9 is a method describing processing of a PCU in a virtual tape system as an example of an embodiment.

FIG. 10 is a method describing an ICP increase/decrease prediction determination technique by a processing unit prediction unit in a virtual tape system as an example of an embodiment.

FIG. 11 is a method describing an ICP increase change processing technique in a virtual tape system as an example of an embodiment.

FIG. 12 is a method describing an ICP increase change processing technique in a virtual tape system as an example of an embodiment.

FIG. 13 is a method describing an ICP increase change processing technique in a virtual tape system as an example of an embodiment.

FIG. 14 is a method describing an ICP decrease change processing technique in a virtual tape system as an example of an embodiment.

FIG. 15 is a method describing an ICP decrease change processing technique in a virtual tape system as an example of an embodiment.

FIG. 16 is a method describing an ICP decrease change processing technique in a virtual tape system as an example of an embodiment.

FIG. 17 is a method describing an IDP increase/decrease prediction determination technique by a processing unit prediction unit in a virtual tape system as an example of an embodiment.

FIG. 18 is a method describing an IDP increase change processing technique in a virtual tape system as an example of an embodiment.

FIG. 19 is a method describing an IDP increase change processing technique in a virtual tape system as an example of an embodiment.

FIG. 20 is a method describing an IDP increase change processing technique in a virtual tape system as an example of an embodiment.

FIG. 21 is a method describing an IDP decrease change processing technique in a virtual tape system as an example of an embodiment.

FIG. 22 is a method describing an IDP decrease change processing technique in a virtual tape system as an example of an embodiment.

FIG. 23 is a method describing an IDP decrease change processing technique in a virtual tape system as an example of an embodiment.

### DESCRIPTION OF EMBODIMENT

Hereinafter, an embodiment will be described with reference to the drawings.

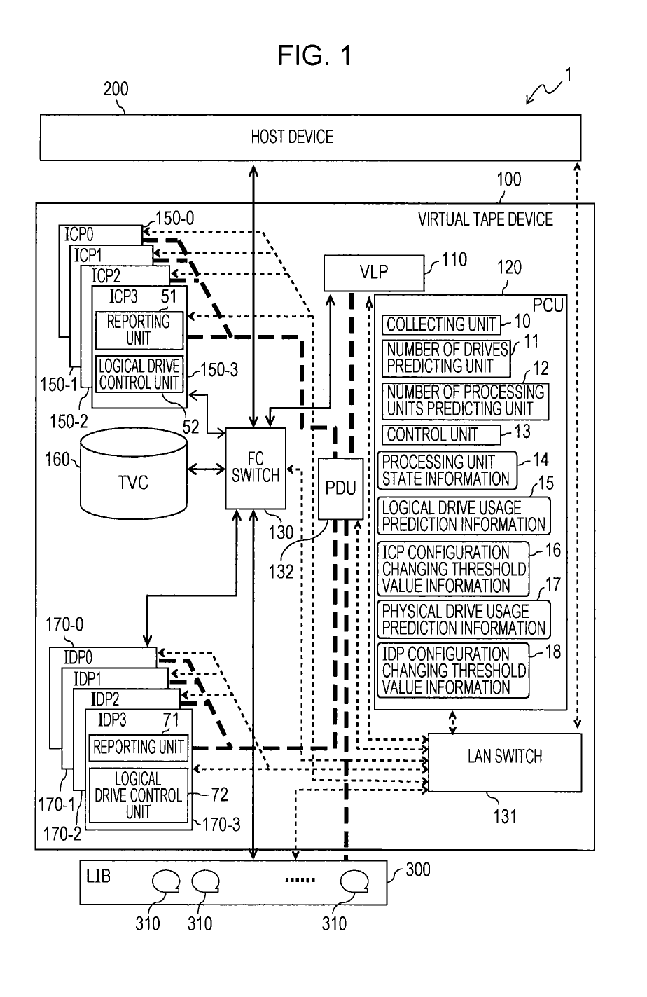

FIG. 1 is a diagram schematically illustrating the configuration of a virtual tape system as an example of the embodiment.

As illustrated in FIG. 1, a virtual tape system 1 has a host device (higher order device) 200, a virtual tape device 100, and a tape library 300.

The host device 200 accesses virtual tapes virtualized by the virtual tape device 100, and cartridge tapes of the tape library 300, to perform writing and reading of data. The host device 200 is communicably connected with a VLP 110, ICPs 150-0 through 150-3, IDPs 170-0 through 170-3, the tape library 300, and a TVC 160, via an FC switch 130. Also, the host device 200 is communicably connected with the VLP 110, ICPs 150-0 through 150-3, IDPs 170-0 through 170-3, tape library 300, a PCU 120, and a PDU 132, via a LAN switch 131.

The host device 200 issues an I/O processing request (read request/write request) to a virtual tape or cartridge tape (physical tape), for example. Particularly, an I/O processing request to a virtual tape is realized by the host device 200 executing a VTCP (Virtual Tape Control Program) by a CPU (Central Processing Unit) that is not illustrated.

The host device 200 transfers and copies data used for business and the like that is stored in a storage device that is not illustrated, for example, to a virtual tape or cartridge tape, periodically or irregularly, thereby backing up data.

This data backup is performed by a virtual tape or cartridge tape for storing the data being specified, for example.

Also, in the event of accessing backed up data in the virtual tape or cartridge tape or the like, the host device 200 first puts a tape drive 310 of the tape library 300 in an online state (ONLINE) and loads the cartridge drive, so as to be in an data-access enabled state (RDY state). For example, the host device issues a command to the tape library 300 such as a VARY ONLINE or the like, thereby placing the tape drive 310 in an RDY state.

Further, at the time of accessing a virtual tape for data backup or the like, the host device 200 first mounts the virtual drive relating to that virtual tape, so as to be in data-access enabled state (RDY state).

Also, upon data access to the cartridge tape or virtual tape ending, the host device 200 takes the tape drive 310 offline, or un-mounts the virtual drive, so as to be in an data-access disabled state (NRDY state).

For example, the host device 200 issues a command to the tape library 300 such as a VARY OFFLINE or the like, thereby placing the tape drive 310 in an NRDY state.

Note that the hardware configuration and function configuration of the host device 200 can be realized using various known techniques, so description thereof will be omitted for sake of convenience.

The tape library 300 performs data writing and reading to the cartridge tape (media). The tape library 300 has multiple tape drives (physical drives) 310, and also has storage racks for storing the multiple cartridge tapes and a transporting mechanism for transporting the cartridge tapes. The transporting mechanism transports selected cartridge tapes out of the multiple cartridge tapes stored in the storage shelves, to the tape drive 310. Note that the cartridge tapes, storage shelves, and transporting mechanism will be omitted from the illustration. Also, the configuration of the tape library 300 can be realized using various known techniques, so description thereof will be omitted for sake of convenience.

Hereinafter, the tape drive 310 may be notated as “PDV”. Also, each of multiple tape drives 310 may be individually notated by appending an identifying numeral identifying the individual tape drive 310 after the PDV.

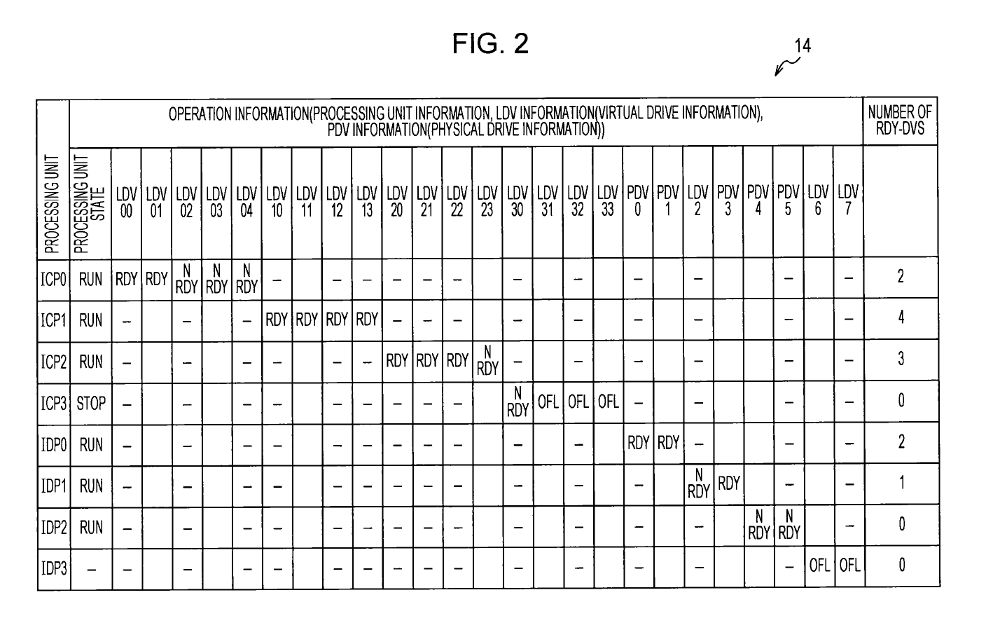

With the embodiment, an example is illustrated where eight tape drives 310, of PDV 0 through 7 are provided to the tape library 300, is illustrated (see FIG. 2).

Also, electric power is supplied to the tape library 300 from a later-described PDU (Power Distribution Unit) 132, and each of the multiple tape drives 310 have electric power supplied thereto from the PDU 132. Also, supply of electric power to each tape drive 310 is controlled by the PDU 132, with electric power supply and electric power stoppage being made to each tape drive 310.

With the tape library 300, cartridge tapes are inserted into and extracted from the tape drives 310 by the transporting mechanism, and data read/write is performed to the cartridge tapes loaded to the tape drives 310.

The virtual tape device 100 is situated between the host device 200 and the tape library 300, and stores data exchanged between the host device 200 and tape library 300 as a virtual tape volume. As illustrated in FIG. 1, the virtual storage device 100 has a VLP (Virtual Library Processor) 110, ICPs (Integrated Channel Processor) 150-0 through 150-3, NC (Tape Volume Cache) 160, IDPs (Integrated Device Processor) 170-0 through 170-3, PCU (Power Control Unit) 120, FC (Fiber Channel) switch 130, LAN (Local Area Network) switch 131, and PDU 132.

The VLP 110, ICPs 150-0 through 150-3, IDPs 170-0 through 170-3, PCU 120, FC switch 130, and PDU 132 are connected via the LAN switch 131 so as to be mutually communicable. Further, the host device 200 and tape library 300 are also connected to the LAN switch 131. Note that the dotted arrows in FIG. 1 represent exchange of data via the LAN switch 131.

Also, the ICPs 150-0 through 150-3, IDPs 170-0 through 170-3, VLP 110 and NC 160 are communicably connected via the FC switch 130. Further, the FC switch 130 is also connected with the host device 200 and the tape library 300. Accordingly, data can be exchanged between the ICP 150 and NC 160, between the NC 160 and the IDPs 170, between the IDPs 170 and the tape drives 310 stored within the tape library 300, and so forth. Note that the solid line arrows in FIG. 1 represent exchange of data via the FC.

With the virtual tape device 100, multiple processes perform communication by pipes or sockets on servers where the ICPs 150-0 through 150-3, IDPs 170-0 through 170-3, and VLP 110 are, thereby realizing a virtual tape system.

Also, the ICPs 150-0 through 150-3, NC 160, IDPs 170-0 through 170-3, VLP 110, PCU 120, FC switch 130, LAN switch 131, PDU 132, and tape library 300 can be configured by being installed in the same rack (omitted from illustration).

The FC switch 130 relays data and the like and switches paths on an optical fiber channel communication path to which the ICPs 150-0 through 150-3, IDPs 170-0 through 170-3, VLP 110, and TVC 160 are connected. Data of a logical volume to be processed by the virtual tape device 100, for example, is transmitted over this optical fiber channel communication path.

The LAN switch 131 relays data and the like and switches paths on a LAN path to which the ICPs 150-0 through 150-3, IDPs 170-0 through 170-3, VLP 110, PCU 120, PDU 132, and FC switch 130 are connected. Communication relating to operation state reference and operation instructions of the processing units of the ICPs 150-0 through 150-3 and IDPs 170-0 through 170-3, for example, is performed over this LAN path. The LAN switch 131 provides distributed connection of the communication thereof to all processing units.

The PDU 132 performs control of electric power supply to the VLP 110, ICPs 150-0 through 150-3, IDPs 170-0 through 170-3, and tape library 300. The PDU 132 supplies electric power to the VLP 110, ICPs 150-0 through 150-3, IDPs 170-0 through 170-3, and tape library 300. For example, the PDU 132 supplies AC 200 V electric power to the VLP 110, ICPs 150-0 through 150-3, IDPs 170-0 through 170-3, and tape library 300. The PDU 132 also stops supply of electric power to the VLP 110, ICPs 150-0 through 150-3, IDPs 170-0 through 170-3, and tape library 300.

The PDU 132 receives instruction signals transmitted from the later-described PCU 120 via the LAN switch 131, by way of a LAN interface that is not illustrated. The PDU 132 follows these instruction signals to control electric power supply to the VLP 110, ICPs 150-0 through 150-3, IDPs 170-0 through 170-3, and tape library 300. In FIG. 1, the heavy dotted lines illustrate electric power supply from the PDU 132. Note that the PDU 132 may also supply electric power to the PCU 120 as well.

The TVC 160 is a storage medium where virtual tape volumes (logical volumes) which are virtual information of cartridge tapes are stored, and provides virtual storage for the ICPs 150-0 through 150-3 and IDPs 170-0 through 170-3. The TVC 160 functions as a virtual storage unit for storing data received by the later-described Cps 150, and data read out from the cartridge tapes of the tape library 300. This TVC 160 is a tape volume cache unit where virtual tape volumes are stored. Note that the term “logical volume” means data in logical access increments when accessing data form the host device 200. The TVC 160 is configured as a RAID (Redundant Arrays of Inexpensive Disks) device, for example.

The VLP 110 is a server computer (processing unit) which cooperates with the ICPs 150-0 through 150-3 and IDPs 170-0 through 170-3 and so forth, to execute (operate) various types of processes which realize the virtual tape environment as a system. The VLP 110 mounts and un-mounts logical volumes to logical drives, and mounts and un-mounts physical volumes of the tape drive 310, in accordance with mounting requests from the host device 200 via the LAN switch 131.

Control of the mounting processing and un-mounting processing of physical volumes is performed by the tape library 300 and a optical fiber channel interface that is not illustrated, via the FC switch 130. The VLP 110 presents the host device 200 with virtual tapes, in cooperation with the ICPs 150-0 through 150-3, IDPs 170-0 through 170-3, and so forth. Note that this VLP 110 is configured as an IA server, for example.

The IDPs 170-0 through 170-3 are server computers (processing units) governing connection between the tape library 300 and tape drives 310. With the present virtual tape system 1, there are multiple (four) IDPs 170-0 through 170-3 provided to the virtual tape device 100, with each controlling tape drives 310 of the tape library 300. The IDPs 170-0 through 170-3 are each of the same configuration.

Note that in the event that a particular IDP of the multiple IDPs has to be identified, the notation of 170-0 through 170-3 will be used, but in the event of indicating any IDP, this will simply be referred to as “IDP 170”. Also, herein after, the IDP 170-0 may be simply written as “IDP0”, and in the same way, the IDP 170-1 may be simply written as “IDP1”, the IDP 170-2 as “IDP2”, and the IDP 170-3 as “IDP3”.

With the embodiment, we will say that the IDPO controls the PDV0 and PDV1, the IDP1 controls the PDV2 and PDV3, the IDP2 controls the PDV4 and PDV5, and the IDP3 controls the PDV6 and PDV7.

Also, note that in the embodiment, of the multiple IDPs, the IDP0, IDP1, IDP2, and IDP3 are operated in that order of priority. That is to say, in the event of transitioning part of the IDPs 170 to a power conservation state, the IDPs 170 to be transitioned to a power conservation state are selected following this order or priority, which will be described later. Also, this order of priority is set beforehand by an operator or the like.

Under instruction from the VLP 110, the IDP 170 writes data of a logical volume on the NC 160 to a cartridge tape using a tape drive 310 of the tape library 300. In the same way, under instruction from the VLP 110, the IDP 170 reads out data of a logical volume from a cartridge tape using a tape drive 310 of the tape library 300, and stores this in the TVC 160.

Also, in response to a data access request from the host device 200, the IDP 170 reads out data from or writes data to a cartridge tape of the tape library 300.

The IDP 170 has functions to serve as a PDS (Physical Driver Server). A PDS is a process of exchanging data with a cartridge tape inserted into a tape drive 310 of the tape library 300, and for example, reads data from a cartridge tape and writes the read data to a predetermined region in the NC 160. Accordingly, the IDP 170 realizes the functions of a physical drive control unit 72 which controls the physical drives of the tape library 300.

Also, upon receiving a state information report command from the later-described PCU 120, the IDP 170 collects processing unit information, PDV information, and the number of PDV RDY, and transmits this information to the IDP 170 as state information.

Now, processing unit information is information indicating whether this IDP 170 is operating or not, and in the event that the IDP 170 is running, “RUN” is notified, and if stopped, “STOP” is notified.

PDV information represents the state of the tape drives 310 which that IDP 170 manages. One of RDY, NRDY, and OFL, for example, is used as the PDV information.

Here, “RDY” means that the tape drive 310 is in a data read/write enabled state, “NRDY” means that the tape drive 310 is not in a data read/write enabled state, and “OFL” means that the power is not on for the tape drive 310.

The number of PDV RDY is the number of tape drives 310 regarding which “RDY” is set for the PDV information. Note that instead of transmitting the number of PDV RDY from the IDP 170 to the PCU 120, an arrangement may be made where the PCU 120 calculates the number of tape drives 310 regarding which “RDY” has been set from the PDV information transmitted from the IDP 170, and this arrangement may be modified as appropriate.

Note that in the state where the power to the IDP 170 is off, a LAN interface (omitted from illustration) provided to the IDP 170 responds to the PCU 120 with a “Link down” response.

Thus, the IDP 170 serves as a reporting unit 71 which compiles state information representing the state of the tape drives 310 which the IDP 170 manages, and transmits this to the IDP 170.

The above-described functions as the reporting unit 71 and physical drive control unit 72 are realized by the CPU (Central Processing Unit, omitted from illustration) of the IDP 170 executing programs stored in a storage device such as memory or a hard disk or the like (omitted from illustration).

The ICPs 150-0 through 150-3 are server computers (processing units) governing connection between the host device 200 and drive path. With the present virtual tape system 1, there are multiple (four) ICPs 150-0 through 150-3 provided to the virtual tape device 100, functioning as reception units to receive data from the host device 200. The ICPs 150-0 through 150-3 each have the same configuration. Note that in the event that a particular ICP of the multiple ICPs has to be identified, the notation of 150-0 through 150-3 will be used, but in the event of indicating any ICP, this will simply be referred to as “ICP 150”.

The ICP 150 is connected to the host device 200 via the FC switch 130, and performs control of exchanging data of virtual tape volumes on the TVC 160 with the host device 200. The ICP 150 access data of the virtual tape volume of the TVC 160 via a logical drive (virtual drive device, omitted from illustration), and performs read/write of data. That is to say, the ICP 150 functions as a processing unit controlling data access to the virtual drive device.

The ICP 150 is configured of an IA server, for example, and realizes the function of EMTAPE (Virtual Emulation Tape). EMTAPE is a process which presents the host device 200 with the tape drives 310 of the tape library 300 in a virtual manner, realizing a logical drive. EMTAPE emulates the physical tape drives 310 of the tape library 300. Thus, the ICP 150 realizes functions as a physical drive control unit 52 which controls the logical drive.

Hereinafter, the logical drive may be notated as “LDV”. Also, each of multiple LDVs may be individually notated by appending an identifying numeral identifying the individual LDV.

With the embodiment, an example is illustrated where the tape library 300 is provided with seventeen logical drives of LDV00 through LDV04, LDV10 through LDV13, LDV20 through LDV23, and LDV30 through LDV33 (see FIG. 2).

Note that in the event that a particular ICP of the multiple ICPs has to be identified, the notation of 150-0 through 150-3 will be used, but in the event of indicating any ICP, this will simply be referred to as “ICP 150”. Also, hereinafter, the ICP 150-0 may be simply written as “ICP0”, and in the same way, the ICP 150-1 may be simply written as “ICP1”, the ICP 150-2 as “ICP2”, and the ICP 150-3 as “ICP3”.

Also, note that in the embodiment, of the multiple ICPs 150, the ICP0, ICP1, ICP2, and ICP3 are operated in that order of priority. That is to say, in the event of transitioning part of the ICPs 150 to a power conservation state, the ICPs 150 to be transitioned to a power conservation state are selected following this order or priority, which will be described later. Also, this order of priority is set beforehand by an operator or the like.

Also, with the embodiment, an example is illustrated where the ICP0 controls the LDV00 through LDV04, the ICP1 controls the LDV10 through LDV13, the ICP2 controls the LDV20 through LDV23, and the ICP3 controls the LDV30 through LDV33, as illustrated in FIG. 2.

Also, upon receiving a state information report command from the later-described PCU 120, the ICP 150 collects the processing unit information, LDV information, and number of LDV RDY, and transmits this information to the IDP 170 as state information.

Now, the processing unit information is information indicating whether or not the ICP 150 is operating, and in the event that the ICP 150 is operating, “RUN” is notified, and if stopped, “STOP” is notified, for example.

The LDV information represents the state of the logical drives which that ICP 150 manages. For example, one of “RDY”, “NRDY”, and “OFL” is used as LDV information.

Here, “RDY” means that the logical drive is mounted and in a data read/write enabled state, while “NRDY” means that the logical drive is not mounted and not in a data read/write enabled state. “OFL” means that a command such as VARY ONLINE or the like from the host device 200 has not been received, and the logical drive is not in a usable state.

The number of LDV RDY is the number of logical drives regarding which “RDY” has been set to the LDV information. Note that an arrangement may be made wherein, instead of transmitting the number of LDV RDY from the ICP 150 to the PCU 120, the PCU 120 calculates the number of logical drives regarding which “RDY” has been set, based on the LDV information transmitted form the ICP 150, and this arrangement may be modified as appropriate.

In this way, the ICP 150 functions as a reporting unit 51 which compiles state information representing the state of the logical drives which that ICP 150 manages, and transmits this to the IDP 170.

The above-described functions as the reporting unit 51 and physical drive control unit 52 are realized by the CPU (omitted from illustration) of the ICP 150 executing programs stored in a storage device such as memory or a hard disk or the like (omitted from illustration).

The PCU 120 is an information processing device having a CPU and memory that are not illustrated, and controls on/off of electric power to the parts making up the virtual tape device 100.

As illustrated in FIG. 1, this PCU 120 has functions as a collecting unit 10, number of drives predicting unit (number of usable drives predicting unit) 11, number of processing units predicting unit 12, and control unit 13.

By the CPU of the information processing device executing programs stored in memory and storage devices that are not illustrated, the PCU 120 functions as the collecting unit 10, number of drives predicting unit 11, number of processing units predicting unit 12, and control unit 13.

Note that the programs for realizing the functions of the collecting unit 10, number of drives predicting unit 11, number of processing units predicting unit 12, and control unit 13, are provided in a form of being recorded in a computer-readable recording medium, examples of which include a flexible disk, CD (CD-ROM, CD-R, CD-RW, etc.), DVD (DVD-ROM, DVD-RAM, DVD-R, DVD+R, DVD-RW, DVD+RW, HD DVD, etc.), Blu-ray disc, magnetic disk, optical disc, and magneto-optical disk. The computer reads the programs from the recording medium, and transfers to an internal storage device or external storage device to be used. Alternatively, the programs may be recorded in storage device (recording media) such as a magnetic disk, optical disc, or magneto-optical disk, for example, so as to be provided to the computer via a communication path from the storage device.

In the event of realizing the functions of the collecting unit 10, number of drives predicting unit 11, number of processing units predicting unit 12, and control unit 13, programs stored in an internal storage device (with the embodiment, RAM or ROM of which illustration is omitted) are executed by a microprocessor (a CPU with the embodiment) of the computer. At this time, the computer may read and execute a program recorded in a recording medium.

Note that with the embodiment, the concept of “computer” includes hardware and operating system, and means hardware running under control of the operating system. Also, in the event of an application program independently causes hardware to run without having to have the system software, the hardware itself is equivalent to the computer. The hardware has at least a microprocessor such as a CPU or the like, and a unit for reading computer programs recorded in a recording medium, so with the embodiment, the PCU 120 has the functions of a computer.

Also, as illustrated in FIG. 1, the PCU 120 stores, in a storage device such as memory or the like which is not illustrated, processing unit state information 14, logical drive usage prediction information 15, ICP configuration changing threshold value information 16, physical drive usage prediction information 17, and IDP configuration changing threshold value information 18.

The collecting unit 10 transmits, to the ICPs 150-0 through 150-3 and IDPs 170-0 through 170-3, a state information report command instructing collecting and transmission of information of the state information of each. Also, the amount of time elapsed after the collecting unit 10 having issued the state information report command is measured using a timer or the like that is not illustrated.

The collecting unit 10 transmits the state information report command to the ICPs 150 and IDPs 170 every first predetermined interval (30 minutes with the embodiment).

Generally, it takes around 30 minutes or so for the PDU 132 to switch online/offline or switch electric power on/off of the ICPs 150 and IDPs 170, and tape drives 310 of the tape library 300. That is to say, the configuration of the ICPs 150 and IDPs 170, and tape drives 310 can be changed in 30-minute increments. Accordingly, setting the intervals at which the collecting unit 10 transmits the state information report command to be around 30 minutes, for example, enables collection of state information to be performed effectively.

Also, in later-described ICP increase changing processing and ICP decrease changing processing, and IDP increase changing processing and IDP decrease changing processing, the collecting unit 10 transmits the state information report command to the ICPs 150 and IDPs 170 at a second predetermined interval (e.g., around one minute intervals) which is shorter than the first predetermined interval. Note that the point-in-time at which the collecting unit 10 has transmitted (issued) the state information report command to the ICPs 150 and IDPs 170 may also be referred to as “monitoring point-in-time”.

Further, in later-described ICP increase changing processing and ICP decrease changing processing, and IDP increase changing processing and IDP decrease changing processing, the collecting unit 10 may place the ICPs 150 and IDPs 170 in a temporary sleep state and then transmit the state information report command to the ICPs 150 and IDPs 170 at a third predetermined interval (e.g., one second intervals) which is shorter than the second predetermined interval.

By making the transmission interval of state information report commands short, state change at the ICPs 150 and IDPs 170 can be speedily comprehended at the PCU 120, and control can be realized with higher precision.

Based on the state information received form the ICPs 150 and IDPs 170, the collecting unit 10 creates processing unit state information 14.

FIG. 2 is a diagram exemplarily illustrating the processing unit state information 14 in the virtual tape system 1 as an example of the embodiment.

The processing unit state information 14 is information representing the state of the ICPs 150 and IDPs 170, and is created by tabulating state information transmitted from the ICPs 150 and IDPs 170, i.e., from each of the processing units.

In the example illustrated in this FIG. 2, the processing unit state information 14 is represented in the form of a table, where the state information transmitted from the ICPs 150 and IDPs 170 has been tabulated.

That is to say, the processing unit state information 14 exemplarily illustrated in FIG. 2 correlates each processing unit with the state of the processing units, and illustrates the states of the logical drives (LDV) and physical drives (PDV) managed by each of the processing units. Specifically, one state each of “RUN” and “STOP” is correlated for each of the ICPs 150 and IDPs 170. Also, one of the states of “RDY”, “NRDY”, and “OFL” is correlated with each LDV and PDV. Further, with the processing unit state information 14 illustrated in FIG. 2, the value obtained by tabulating the number of drives in a “RDY” state is correlated with each processing unit as “number of RDY-DV”. Note that hereinafter, the number of RDY-DV may also be called number in use or another like expression.

With the virtual tape system 1, referencing the processing unit state information 14 enables the number of logical drives and physical drives in the “RDY” state to be easily known. In the same way, the number of ICPs 150 and IDPs 170 operating in the virtual tape system 1 can be easily found.

Also, the state information which the collecting unit 10 has connected is saved in a storage device that is not illustrated, such as an HDD (hard disk drive), SSD (Solid State Drive), memory, or the like. Such state information is saved in the virtual tape device 100 for a predetermined amount of time (e.g., at least one month).

Based on the state information of the drive devices in the ICPs 150 and IDPs 170 as collected by the collecting unit 10, the number of drives predicting unit 11 predicts the number of drive devices in use a predetermined amount of time later, and creates logical drive usage prediction information 15 and physical drive usage prediction information 17.

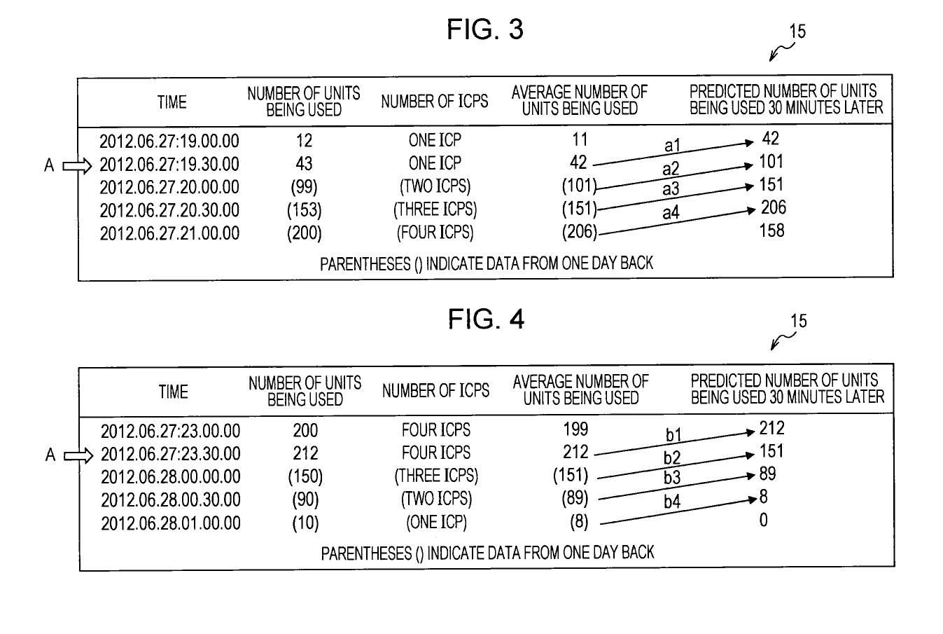

FIGS. 3 and 4 are each diagrams exemplarily illustrating the logical drive usage prediction information 15 with the virtual tape system 1.

For example, the number of drives predicting unit 11 totals the number of LDV RDY (state information) received from each ICP 150, and calculates the number of logical drives begin used at the point-in-time of collecting that state information.

Also, based on the received number of LDV RDY and the number of LDV RDY in the same time slot for a predetermined period (e.g., one month) in the past, the number of drives predicting unit 11 calculates the average value of number of LDV RDY (average number of usage). Note that the method of calculating the average value of number of LDV RDY may be changed as appropriate. For example, the period for calculating the average value may be a period other than one month, and further, various modifications may be made such as extracting and using values from the same day of the week, a particular day of the week, or the like.

For example, in the event that a backup schedule is implemented with the virtual tape system 1 in increments of weeks, the average number in use is preferably calculated at the same time of day in increments of days of the week. Also, the calculation method whereby the average number of use is calculated is preferably switchable, in accordance with setting information which an operator has registered in the PCU 120 beforehand, for example.

Further, of the LDV information (state information) received from the ICPs, the number of drives predicting unit 11 totals the number of ICPs 150 in the “RDY” state, and calculates the number of ICPs 150 (number of ICPs) operating at the point-in-time of collecting that information.

The number in use, the number of ICPs, and the average number in use, which the number of drives predicting unit 11 has calculated, is stored in a storage device such as an HDD, SSD, memory, or the like which is not illustrated.

The number of drives predicting unit 11 stores the number in use, the number of ICPs, and the average number in use, which is has calculated, in the later-described logical drive usage prediction information 15, in a manner correlated with the point-in-time at which that state information was collected. Note that the point-in-time at which the state information was collected is preferably the point-in-time at which the collecting unit 10 has transmitted the state information report command. Accordingly, situations can be easily handled even in the event that there is different at the reception point-in-time of the state information from some of the ICPs 150 and IDPs 170.

Also, with regard to a point-in-time in the logical drive usage prediction information 15 at which the number in use, the number of ICPs, and the average number in use, is not being calculated, the number of drives predicting unit 11 extracts past calculation results stored in the storage device, and correlates as prediction values. For example, the number of drives predicting unit 11 extracts from the storage device the values of the number in use, the number of ICPs, and the average number in use, calculated the day before, and uses these values as the prediction values at the same time slot in the logical drive usage prediction information 15.

Each time the collecting unit 10 collects state information from the ICPs 150, i.e., every 30 minutes with the embodiment, the number of drives predicting unit 11 updates the logical drive usage prediction information 15 based on the received state information.

Note that the logical drive usage prediction information 15 illustrated exemplarily in FIGS. 3 and 4 indicates the state after having performed an update (see arrow A) based on state information collected at 19:30 on Jun. 27, 2012 (monitoring point-in-time: 2012.06.27.19:30). Hereinafter, the monitoring point-in-time at which the state information update was last performed, indicated by the arrow A, may also be referred to as “current point-in-time”.

With the logical drive usage prediction information 15 illustrated in these FIGS. 3 and 4, the values of the number in use, the number of ICPs, and the average number in use, which the number of drives predicting unit 11 actually calculated (actual measurement values) are stored up to 19:30 on Jun. 27, 2012. After monitoring point-in-time, i.e., current point-in-time, that is to say after the monitoring point-in-time was 20:00 on Jun. 27, 2012, the values (actually measured values) of the number in use, the number of ICPs, and the average number in use, calculated the day before (Jun. 26, 2012) are stored as prediction values. Note that in FIG. 3, the values of the previous day (one day ago), i.e., prediction values, are each indicated by being in parentheses ( ).

Also, with the logical drive usage prediction information 15, the “average number in use” 30 minutes after each monitoring point-in-time is set as “predicted number of units in use 30 minutes later” (see arrows a1 through a3 and b1 through b4). In the event that the average number in use from the previous day (prediction value) is to be used as the average number in use, such as for the current point-in-time or the like, the average number in use of the day before is used as the “predicted number of units in use 30 minutes later”. That is to say, the number of drives predicting unit 11 predicts the number of logical drives in use a predetermined amount of time later, based on the state information of the drive devices at each ICP 150 collected by the collecting unit 10. Hereinafter, the predicted number of units in use of logical drives a predetermined amount of time later may be referred to as predicted number of units in use. Note that the values of “predicted number of units in use” and “predicted number of units in use 30 minutes later” are rounded up the closest whole number.

For example, with the example illustrated in FIG. 3, at the point that the monitoring point-in-time of 19:30 on Jun. 27, 2012 has passed, for the “average number of units in use” at 20:00 on Jun. 27, 2012, the value “101” calculated at the same point-in-time of the previous day, i.e., at 20:00 on Jun. 26, 2012, is set. This 101, which is the “average number of units in use”, is also used as the “predicted number of units in use 30 minutes later” for 19:30 on Jun. 27, 2012 (see arrow a2).

Note that with the embodiment, the value of the previous data stored in the storage device as a past calculation result is used in the logical drive usage prediction information 15 of a point-in-time at which the number of units in use, number of ICPs, and average number of units in use, have not been calculated, but is not restricted to this arrangement. For example, values from the previous business day, the immediately preceding same day of the week, and so forth, may be used as past calculation results, and this may be changed as appropriate.

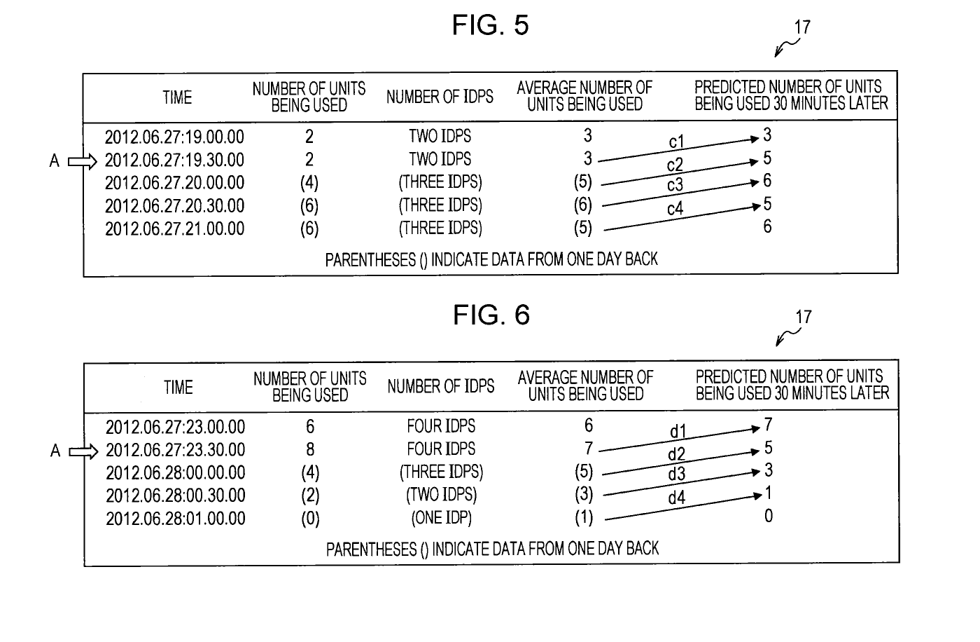

FIGS. 5 and 6 are each diagrams exemplarily illustrating the physical drive usage prediction information 17 with the virtual tape system 1, as an example of the embodiment.

The number of drives predicting unit 11 totals the number of PDV RDY (state information) received from each IDP 170, and calculates the number of physical drives begin used at the point-in-time of collecting that state information.

Also, based on the received number of PDV RDY and the number of PDV RDY in the same time slot for a predetermined period (e.g., one month) in the past, the number of drives predicting unit 11 calculates the average value of number of PDV RDY (average number of usage). Note that the method of calculating the average value of number of PDV RDY may be changed as appropriate. For example, the period for calculating the average value may be a period other than one month in the past, and further, various modifications may be made such as extracting and using values from the same day of the week, a particular day of the week, or the like.

For example, in the event that a backup schedule is implemented with the virtual tape system 1 in increments of weeks, the average number in use is preferably calculated at the same time of day in increments of days of the week. Also, the calculation method whereby the average number of use is calculated is preferably switchable, in accordance with setting information which an operator has registered in the PCU 120 beforehand, for example.

Further, of the PDV information (state information) received from the IDPs 170, the number of drives predicting unit 11 totals the number of IDPs 170 in the “RDY” state, and calculates the number of IDPs 170 (number of IDPs) operating at the point-in-time of collecting that state information.

The number in use, the number of IDPs, and the average number in use, which the number of drives predicting unit 11 has calculated, is stored in a storage device such as a had disk drive, SSD, memory, or the like which is not illustrated.

The number of drives predicting unit 11 stores the number in use, the number of IDPs, and the average number in use, which it has calculated, in the later-described physical drive usage prediction information 17, in a manner correlated with the point-in-time at which that state information was collected. Note that the point-in-time at which the state information was collected is preferably the point-in-time at which the collecting unit 10 has transmitted the state information report command. Accordingly, situations can be easily handled even in the event that there is different at the reception point-in-time of the state information from some of the ICPs 150 and IDPs 170.

Also, with regard to a point-in-time in the physical drive usage prediction information 17 at which the number in use, the number of IDPs, and the average number in use, is not being calculated, the number of drives predicting unit 11 extracts past calculation results stored in the storage device, and correlates as prediction values. For example, the number of drives predicting unit 11 extracts from the storage device the values of the number in use, the number of IDPs, and the average number in use, calculated the day before, and uses these values as the prediction values at the same time slot in the physical drive usage prediction information 17.

Each time the collecting unit 10 collects state information from the IDPs 170, i.e., every 30 minutes with the embodiment, the number of drives predicting unit 11 updates the physical drive usage prediction information 17 based on the received state information.

Note that the physical drive usage prediction information 17 illustrated exemplarily in FIGS. 5 and 6 indicates the state after having performed an update (see arrow A) based on state information collected at 19:30 on Jun. 27, 2012 (monitoring point-in-time: 2012.06.27.19:30).

With the logical drive usage prediction information 15 illustrated in these FIGS. 5 and 6, the values of the number in use, the number of IDPs, and the average number in use, which the number of drives predicting unit 11 has actually calculated (actual measurement values) are stored up to 19:30 on Jun. 27, 2012. After the monitoring point-in-time was 20:00 on Jun. 27, 2012, the values (actually measured values) of the number in use, the number of IDPs, and the average number in use, calculated the day before (Jun. 26, 2012) are stored as prediction values. Note that in FIGS. 5 and 6, the values of the previous day (one day ago) are each indicated by being in parentheses ( ).

Also, with the physical drive usage prediction information 17, the “average number in use” 30 minutes after each monitoring point-in-time is set as “predicted number of units in use 30 minutes later” (see arrows c1 through c3 and d1 through d4), in accordance with each point-in-time. In the event that the average number in use from the previous day (prediction value) is to be used as the average number in use, such as for the current point-in-time or the like, the average number in use of the day before is used as the “predicted number of units in use 30 minutes later”. That is to say, the number of drives predicting unit 11 predicts the number of tape drives 310 in use a predetermined amount of time later, based on the state information of the tape drives 310 at each IDP 170 collected by the collecting unit 10. Hereinafter, the predicted number of units in use of tape drives 310 a predetermined amount of time later may be referred to as predicted number of units in use. Note that the values of “predicted number of units in use” and “average number of units in use 30 minutes later” are rounded up the closest whole number.

For example, with the example illustrated in FIG. 5, at the point that the monitoring point-in-time of 19:30 on Jun. 27, 2012 has passed, for the “average number of units in use” at 20:00 on Jun. 27, 2012, the value “5” calculated at the same point-in-time of the previous day, i.e., at 20:00 on Jun. 26, 2012, is set. This 5, which is the “average number of units in use”, is also used as the “predicted number of units in use 30 minutes later” for 19:30 on Jun. 27, 2012 (see arrow c2).

Note that with the embodiment, the value of the previous data stored in the storage device as a past calculation result is used in the physical drive usage prediction information 17 of a point-in-time at which the number of units in use, number of IDPs, and average number of units in use, have not been calculated, but is not restricted to this arrangement. For example, values from the previous business day, the immediately preceding same day of the week, and so forth, may be used as past calculation results, and this may be changed as appropriate.

The number of processing units predicting unit 12 predicts the demanded number of ICPs 150 after a predetermined amount of time, based on the predicted number of logical drives in use (predicted number of units in use) predicted by the number of drives predicting unit 11 and the ICP configuration changing threshold value information (number of units restriction information) 16.

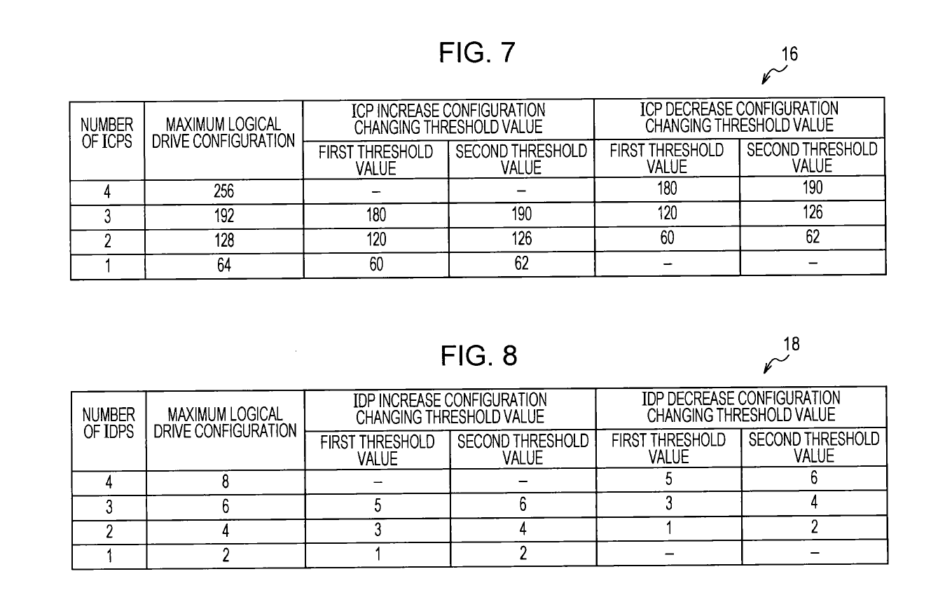

FIG. 7 is a diagram exemplarily illustrating the ICP configuration changing threshold value information 16 according to the virtual tape system 1 as an example of the embodiment.

The ICP configuration changing threshold value information 16 is information indicating the relation between the number of ICPs 150 and the number of logical drives (drive devices), and the number of processing units predicting unit 12 comprehends the number of ICPs 150 demanded by referencing this ICP configuration changing threshold value information 16. With the example illustrated in FIG. 7, the ICP configuration changing threshold value information 16 correlates the number of ICPs with maximum logical drive configuration, threshold of change of ICP increase configuration, and threshold of change of ICP decrease configuration.

Here, the number of ICPs the number of ICPs 150, with integers of 1 through 4 illustrated in the example in FIG. 7. The maximum logical drive configuration is the maximum number of logical drives which can be managed with each number of ICPs. With the example in FIG. 7, one ICP 150 can manage a maximum of 64 logical drives, so the maximum logical drive configuration is the value obtained by multiplying the number of ICPs by 64. For example, if there are three ICPs, i.e., in the event of using three ICPs 150, a maximum of 192 (3×64=192) logical drives can be used.

Accordingly, the ICP configuration changing threshold value information 16 functions as number of units restriction information, indicating the number of logical drives to be controlled by the ICPs 150.

The number of processing units predicting unit 12 references the ICP configuration changing threshold value information 16 based on the “number of units in use 30 minutes later” which the ICP 150 has predicted (see FIGS. 3 and 4), thereby predicting the number of ICPs 150 in demand 30 minutes later.

For example, with the example illustrated in FIG. 3, at the point of 19:30 on Jun. 27, 2012 (2012.06.27.19:30) (see arrow A), the number of logical drives in use is 43, and these 43 logical drives can be managed by one ICP 150. The “number of units in use 30 minutes later” is 101, and referencing the ICP configuration changing threshold value information 16 we can see that this is greater than 64 logical drives which is the number that one ICP 150 can manage. We can further see from the ICP configuration changing threshold value information 16 that at least two ICPs 150 have to be used to manage the 101 logical drives. That is to say, the number of processing units predicting unit 12 references the ICP configuration changing threshold value information 16 based on the “number of units in use 30 minutes later” predicted by the number of drives predicting unit 11, thereby predicting the number of ICPs 150 in demand (demanded number) 30 minutes later (after predetermined time).

Note that a state in which the predicted number of ICPs 150 in use after this predetermined time has elapsed increases over the average number of units in use at the current point-in-time may be referred to as an increase tendency in the predicted number of units. Also, a state in which the predicted number of ICPs 150 in use after this predetermined time has elapsed decreases over the average number of units in use at the current point-in-time may be referred to as a decrease tendency in the predicted number of units.

With the point-in-time at 19:30 on Jun. 27, 2012 (see arrow A), the number of logical drives being used is 43, and these 43 logical drives can be managed with one ICP 150. The “number of units in use 30 minutes later” is 101, meaning that two ICPs 150 are in demand. Accordingly, this is a increase tendency in the predicted number of ICPs 150 from one to two.

The threshold of change of ICP increase configuration is a threshold value used for determining the number of ICPs 150 to be used at the increase tendency in the predicted number of ICPs 150 (see FIG. 3), and there is a first threshold value and a second threshold value. The second threshold value is greater than the first threshold value, and also is smaller than the value of the corresponding maximum logical drive configuration. The first threshold value is greater than the value of maximum logical drive configuration of a number of ICPs one less than the number of ICPs corresponding to this first threshold value.

The threshold of change of ICP decrease configuration is a threshold value used for determining the number of ICPs 150 to be used at the decrease tendency in the predicted number of ICPs 150 (see FIG. 4), and there is a first threshold value and a second threshold value. The second threshold value is greater than the first threshold value, and also is smaller than the value of the corresponding maximum logical drive configuration. The second threshold value is smaller than the value of maximum logical drive configuration of a number of ICPs one less than the number of ICPs corresponding to this second threshold value.

The ICP configuration changing threshold value information 16 is stored in a storage device such as memory or like that is not illustrated. Accordingly, the storage device such as memory functions as a recording unit recording the ICP configuration changing threshold value information 16.

Note that a technique for determining the number of ICP 150, using the ICP configuration changing threshold value information 16, will be described later.

Also, as the result of prediction of the number of ICPs 150 in demand, in the event that there is an increase tendency in the predicted number of ICPs 150, the number of processing units predicting unit 12 sets “1”, for example, to a first increase flag, and in the event that there is an decrease tendency in the predicted number of ICPs 150, the number of processing units predicting unit 12 sets “1”, for example, to a first decrease flag.

The first increase flag and first decrease flag are saved in a storage device such as memory or the like that is not illustrated, for example.

Based on the predicted number of tape drives 310 predicted by the number of drives predicting unit 11 (predicted number of units in use) and IDP configuration changing threshold value information (number of units restriction information) 18, the number of processing units predicting unit 12 predicts the number of IDPs 170 in demand a predetermined amount of time later.

FIG. 8 is a diagram exemplarily illustrating the IDP configuration changing threshold value information 18 of the virtual tape system 1 as an example of the embodiment.

The IDP configuration changing threshold value information 18 is information representing the relation between the number of IDPs 170 and tape drives 310 (drive devices, physical drives), and the number of processing units predicting unit 12 comprehends the number of IDPs 170 in demand by referencing this IDP configuration changing threshold value information 18. In the example illustrated in FIG. 8, the IDP configuration changing threshold value information 18 correlates the number of IDPs with maximum logical drive configuration, threshold of change of IDP increase configuration, and threshold of change of IDP decrease configuration.

The number of IDPs is the number of IDPs 170, with integers of 1 through 4 illustrated in the example in FIG. 8. The maximum logical drive configuration is the maximum number of logical drives which can be managed with each number of IDPs. With the example in FIG. 8, one IDP 170 can manage a maximum of two logical drives, so the maximum logical drive configuration is the value obtained by multiplying the number of IDPs by 2. For example, if there are three IDPs, i.e., in the event of using three IDPs 170, a maximum of six (3×2=6) logical drives can be used.

Accordingly, the IDP configuration changing threshold value information 18 functions as number of units restriction information, indicating the number of logical drives to be controlled by the IDPs 170.

The number of processing units predicting unit 12 references the IDP configuration changing threshold value information 18 based on the “number of units in use 30 minutes later” which the IDP 170 has predicted (see FIGS. 5 and 6), thereby predicting the number of IDPs 170 in demand 30 minutes later.

For example, with the example illustrated in FIG. 5, at the point of 19:30 on Jun. 27, 2012 (2012.06.27.19:30) (see arrow A), the number of tape drives 310 in use is three, and these three tape drives 310 can be managed by two IDPs 170. The “number of units in use 30 minutes later” is 5, and referencing the IDP configuration changing threshold value information 18 we can see that at least three IDPs 170 have to be used to manage the five tape drives 310. That is to say, the number of processing units predicting unit 12 references the IDP configuration changing threshold value information 18 based on the “number of units in use 30 minutes later” predicted by the number of drives predicting unit 11, thereby predicting the number of IDPs 170 in demand (demanded number) 30 minutes later (after predetermined time).

Note that a state in which the predicted number of IDPs 170 in use after this predetermined time has elapsed increases over the average number of units in use at the current point-in-time may be referred to as an increase tendency in the predicted number of units. Also, a state in which the predicted number of IDPs 170 in use after this predetermined time has elapsed decreases over the average number of units in use at the current point-in-time may be referred to as a decrease tendency in the predicted number of units.

The threshold of change of IDP increase configuration is a threshold value used for determining the number of IDPs 170 to be used at the increase tendency in the predicted number of IDPs 170 (see FIG. 5), and there is a first threshold value and a second threshold value. The second threshold value is greater than the first threshold value, and also is smaller than the value of the corresponding maximum physical drive configuration. The first threshold value is greater than the value of maximum physical drive configuration of a number of IDPs one less than the number of IDPs corresponding to this first threshold value.

The threshold of change of IDP decrease configuration is a threshold value used for determining the number of IDPs 170 to be used at the decrease tendency in the predicted number of IDPs 170 (see FIG. 6), and there is a first threshold value and a second threshold value. The second threshold value is greater than the first threshold value, and also is smaller than the value of the corresponding maximum physical drive configuration. The second threshold value is smaller than the value of maximum physical drive configuration of a number of IDPs one less than the number of IDPs corresponding to this second threshold value.

The IDP configuration changing threshold value information 18 is stored in a storage device such as memory or like that is not illustrated. Accordingly, the storage device such as memory functions as a recording unit recording the IDP configuration changing threshold value information 18.

Note that a technique for determining the number of IDP 170, using the IDP configuration changing threshold value information 18, will be described later.

Also, as the result of prediction of the number of IDPs 170 in demand, in the event that there is an increase tendency in the predicted number of IDPs 170, the number of processing units predicting unit 12 sets “1”, for example, to a second increase flag, and in the event that there is an decrease tendency in the predicted number of IDPs 170, the number of processing units predicting unit 12 sets “1”, for example, to a second decrease flag.

The second increase flag and second decrease flag are saved in a storage device such as memory or the like that is not illustrated, for example.

By transmitting an instruction signal to the PDU 132, the control unit 13 can start electric power supply or stop electric power supply from the PDU 132 to the ICPs 150 and IDPs 170, and the tape drives 310 (PDV) of the tape library 300. That is to say, the control unit 13 controls electric power supply to the ICPs 150 and IDPs 170 based on the number of ICPs 150 and IDPs 170 in demand predicted by the number of processing units predicting unit 12.

The instruction signal transmitted to the PDU 132 includes a command for starting or stopping supply of electric power, and information for identifying the object (e.g., ICP 150, IDPs 170, or tape drive 310) to start or stop electric power supply.

For example, in the event of turning on power to a particular ICP 150 (e.g., ICP0), the control unit 13 outputs an instruction to supply AC 200 V electric power to the ICP0 (power-on instruction) to the PDU 132 via the LAN switch 131. Upon AC 200 V being supplied form the PDU 132, the ICP 150 executes start up processing according to a startup program. After startup, the ICP 150 sets all logical drives thereupon (e.g., 60) to an ONLINE and NOT READY state.

In the same way, in the event of turning on power to a particular IDP 170 or tape drive 310 (e.g., IDP2, PDV4, PDV5), an instruction to supply AC 200 V electric power to the IDP2, PDV4, and PDV5 (power-on instruction) is output to the PDU 132 via the LAN switch 131. Upon AC 200 V being supplied form the PDU 132, the IDP 170 executes start up processing according to a startup program. After startup, the IDP 170 sets the physical drives connected thereto to an ONLINE and NOT READY state.

Also, the control unit 13 transmits an operation stop instruction to ICPs 150. Upon receiving the operation stop instruction, the ICP 150 immediately sets NOT READY logical drives to OFFLINE. Also, READY logical drives continue to operate in a READY state until an unload command is received from the host device 200, and go OFFLINE at the point that the unload command is received. After having configured that all logical drives on the ICP have gone OFFLINE, the control unit 13 stops supply of electric power to the ICP 150. Stopping electric power supply may also be expressed as shutting down power.

As for the method of stopping electric power supply to an ICP 150, for example, a shutdown command is issued to the relevant ICP 150 from the control unit 13 via the LAN switch 131. Thereafter, the PCU 120 is caused to cut off the AC 200 V electric power supply to that ICP 150.

Further, the control unit 13 transmits an operation stop instruction to IDPs 170. Upon receiving the operation stop instruction, the IDP 170 immediately sets NOT READY tape drives 310 to OFFLINE. Also, tape drives 310 continue to operate in a READY state until an unload command is received from the host device 200, and go OFFLINE at the point that the unload command is received. After all physical drives on the IDP have gone OFFLINE, the control unit 13 stops supply of electric power to the IDP 170 and the PDV. As for the method of stopping electric power supply to the IDP 170 and PDVs, for example, a shutdown command is issued to the relevant IDP 170 and PDV from the PCU 120 via the LAN switch 131. Thereafter, the control unit 13 cuts off the AC 200 V electric power supply to the IDP 170 and PDV via the PDU 132.

The control unit 13 then runs the number of ICPs 150 in demand which the number of processing units predicting unit 12 has predicted, and transitions the other ICPs 150 to a power conservation state. In the same way, the control unit 13 runs the number of IDPs 170 in demand which the number of processing units predicting unit 12 has predicted, and transitions the other IDPs 170 to a power conservation state.

Note that the power conservation state of the ICPs 150 and IDPs 170 is not restricted to the above-described technique of stopping the processes of the ICPs 150 and IDPs 170 and completely cutting off the electric power supply. That is to say, instead of a shutdown, the ICPs 150 and IDPs 170 may be put to sleep (standby) where the data being handled is evacuated to memory, and electric power is supplied to the memory, or an inoperative state where the data being handled is written to a hard disk and then the electric power supply is cut off, and the arrangement may be changed as appropriate. In the following, description will be made regarding an example of shutting down the ICPs 150 and IDPs 170 as an example of power conservation state.

Note that with the embodiment, the control unit 13 selects the ICPs 150 and IDPs 170 to transition to a power conserving state, following the order of priority set beforehand, for example. Note that a technique for selecting the ICPs 150 and IDPs 170 to transition to a power conserving state is not restricted to this, and may be changed as appropriate.

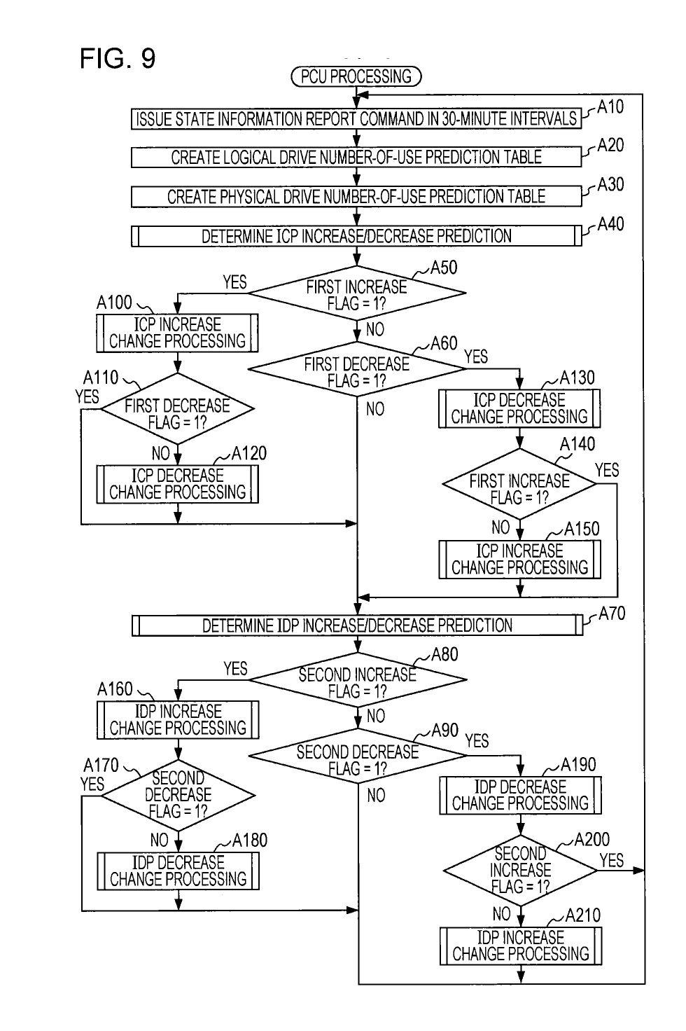

Processing of the PCU 120 in the virtual tape system 1 configured as described above as one example of the embodiment will be described with reference to the method illustrated in FIG. 9 (steps A10 through A210).

At the PCU 120, the collecting unit 10 transmits a state information report command to the ICPs 150 and IDPs 170 via the LAN, every first predetermined interval (e.g., 30 minutes) (step A10).

Upon receiving the state information report command from the PCU 120, the reporting units 51 and 71 of the ICPs 150 and IDPs 170 collect the state information and responds to the PCU 120 with this state information.

Based on the received state report, the collecting unit 10 creates processing unit state information 14.

Next, at the PCU 120, based on the state information received from each ICP 150, the number of drives predicting unit 11 creates logical drive usage prediction information 15 (step A20). Also, based on the state information received from each IDP 170, the number of drives predicting unit 11 creates physical drive usage prediction information 17 (step A30).

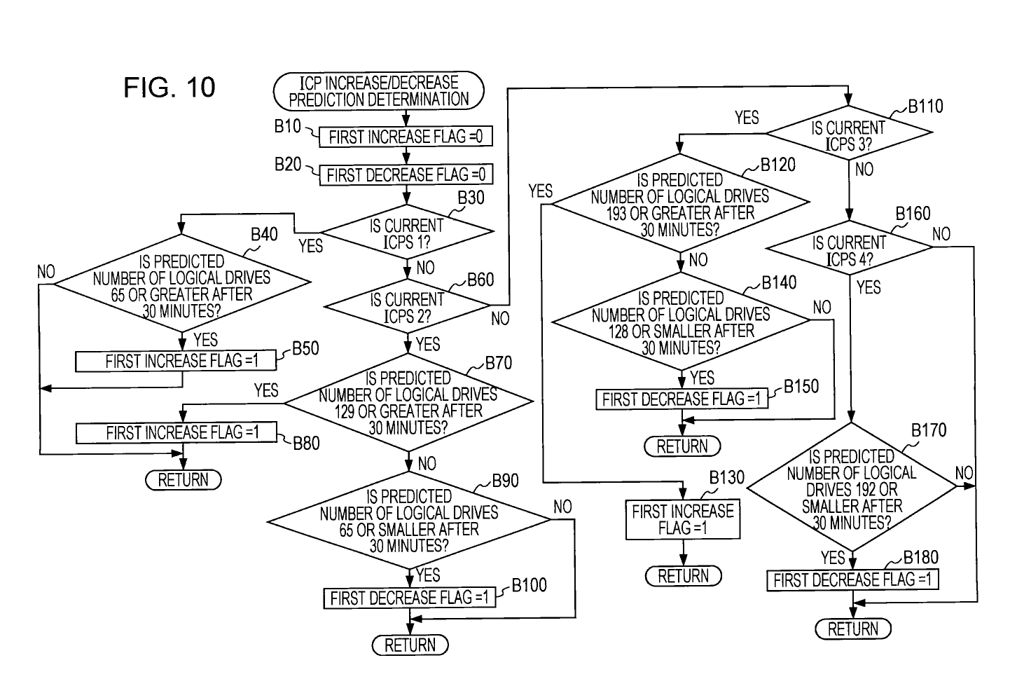

The number of processing units predicting unit 12 then predicts the number of ICPs 150 in demand 30 minutes later, based on the “predicted number of units in use 30 minutes later” predicted by the drive number predicting unit 11, and the ICP configuration changing threshold value information 16. Accordingly, the number of processing units predicting unit 12 performs prediction determination of increase/decrease of the number of ICPs 150 (step A40). The increase/decrease prediction determination technique of the ICPs 150 by the number of processing units predicting unit 12 will be described later with reference to the method in FIG. 10.

First, determination is made by the number of processing units predicting unit 12 regarding whether or not 1 is set to the first increase flag (first increase flag=1) (step A50). In the event that 1 is not set to the first increase flag (see the NO route in step A50), the number of processing units predicting unit 12 then determines whether or not 1 is set to the first decrease flag (first decrease flag=1) (step A60).

In the event that 1 is not set to the first decrease flag (see the NO route in step A60), the number of processing units predicting unit 12 predicts the number of IDPs 170 in demand 30 minutes layer, based on the “predicted number of units in use 30 minutes later” and the IDP configuration changing threshold value information 18. Accordingly, the number of processing units predicting unit 12 performs prediction determination of increase/decrease of the number of IDPs 170 (step A70).

Next, determination is made by the number of processing units predicting unit 12 regarding whether or not 1 is set to the second increase flag (second increase flag=1) (step A80). In the event that 1 is not set to the second increase flag (see the NO route in step A80), the number of processing units predicting unit 12 then determines whether or not 1 is set to the second decrease flag (second decrease flag=1) (step A90). In the event that 1 is not set to the second decrease flag (see the NO route in step A90), the flow returns to step A10.

Also, in the event that 1 is set to the first increase flag (see the YES route in step A50), the control unit 13 performs ICP increase change processing where the number of ICPs 150 running is increased (step A100). Details of the ICP increase change processing will be described later.

Subsequently, the number of processing units predicting unit 12 confirms that the first decrease flag is set to 1 (step A110). In the event that the first decrease flag is not set to 1 (see the NO route in step A110), the control unit 13 performs ICP decrease change processing to reduce the number of ICPs 150 (step A120), and transitions to step A70. Details of the ICP decrease change processing will be described later.

On the other hand, in the event that as a result of confirmation by the number of processing units predicting unit 12, 1 is set to the first decrease flag (see the YES route in step A60), the control unit 13 performs ICP decrease change processing where the number of ICPs 150 running is decreased (step A130).

Thereafter, the number of processing units predicting unit 12 confirms whether or not 1 is set to the first increase flag (step A140). In the event that 1 is not set to the first increase flag (see the NO route in step A140), the control unit 13 performs ICP increase change processing where the number of ICPs 150 running is increased (step A150), and the flow transitions to step A70.

In step A70, the number of processing units predicting unit 12 predicts the number of IDPs 170 in demand 30 minutes layer, based on the “predicted number of units in use 30 minutes later” predicted by the number of drives predicting unit 11, and the IDP configuration changing threshold value information 18. Accordingly, the number of processing units predicting unit 12 performs prediction determination of increase/decrease of the number of IDPs 170.

Determination is then made by the number of processing units predicting unit 12 regarding whether or not 1 is set to the second increase flag (second increase flag=1) (step A80). In the event that 2 is set to the first increase flag (see the YES route in step A80), the control unit 13 performs IDP increase change processing where the number of IDPs 170 running is increased (step A160). Note that this IDP increase change processing will be described in detail later.

Thereafter, the number of processing units predicting unit 12 confirms whether or not 1 is set to the second decrease flag (step A170). In the event that 1 is not set to the second decrease flag (see the NO route in step A170), the control unit 13 performs IDP decrease change processing where the number of IDPs 170 running is decreased (step A180), and the flow returns to step A10. Note that this IDP decrease change processing will be described in detail later.

On the other hand, in the event that as a result of confirmation by the number of processing units predicting unit 12, 1 is not set to the second increase flag (see the NO route in step A80), confirmation is then made regarding whether or not 1 is set to the second decrease flag (step A90).

In the event that 1 is not set to the second decrease flag (see the NO route in step A90), the flow returns to step A10. In the event that 1 is set to the second decrease flag (see the YES route in step A90), the control unit 13 performs IDP decrease change processing where the number of IDPs 170 running is decreased (step A190).

Thereafter, the number of processing units predicting unit 12 confirms whether or not 1 is set to the second increase flag (step A200). In the event that 1 is not set to the second increase flag (see the NO route in step A200), the control unit 13 performs IDP increase change processing to increase the number of IDPs 170 running (step A210), and the flow returns to step A10. Note that this IDP increase change processing will also be described in detail later.

Next, the increase/decrease prediction determination technique for ICPs 150 (see step A40 in FIG. 9) by the number of processing units predicting unit 12 of the virtual tape system 1 as an example of the embodiment will be described with reference to the method in FIG. 10 (steps B10 through B180). Note that with this example, the number of processing units predicting unit 12 performs increase/decrease prediction determination for ICPs 150 based on the ICP configuration changing threshold value information 16 exemplarily illustrated in FIG. 7.

First, the number of processing units predicting unit 12 initializes the first increase flag and first decrease flag by setting 0 thereto (Steps B10 and B20), and then confirms whether or not the number of ICPs 150 currently running is one, by referencing the logical drive usage prediction information 15, for example (step B30).

In the event that the number of ICPs 150 currently running is one (see the YES route in step B30), the number of processing units predicting unit 12 reads out the value for the “predicted number of units in use 30 minutes later” corresponding to the point-in-time from the logical drive usage prediction information 15.

The number of processing units predicting unit 12 compares the value of this “predicted number of units in use 30 minutes later” with the value of the maximum logical drive configuration when the number of ICPs 150 read out from the ICP configuration changing threshold value information 16 is one (64). That is to say, the number of processing units predicting unit 12 confirms whether or not the predicted number of logical drives in use 30 minutes later is 65 or more (step B40).

In the event that the predicted number of logical drives in use 30 minutes later is 64 or less (see the NO route in step B40), the flow transitions to the processing of step A50 in FIG. 9. On the other hand, in the event that the predicted number of logical drives in use 30 minutes later is 65 or greater (see the YES route in step B40), 1 is set to the first increase flag (step B50), and the flow advances to the processing in step A50 in FIG. 9.

In the event that the number of ICPs 150 currently running is not one (see the NO route in step B30), next, whether or not the number of ICPs 150 currently running is two is confirmed (step B60).

In the event that the number of ICPs 150 currently running is two (see the YES route in step B60), the number of processing units predicting unit 12 compares the value of “predicted number of units in use 30 minutes later” read out from the logical drive usage prediction information 15 with the maximum logical drive configuration value (128) at the time of two ICPs 150 read out from the ICP configuration changing threshold value information 16. That is to say, confirmation is made regarding whether or not the predicted number of logical drives in use 30 minutes later is 129 or more (step B70).

In the event that the predicted number of logical drives in use 30 minutes later is 129 or more (see the YES route in step B70), the first increase flag is set to 1 (step B80) and then the flow transitions to the processing of step A50 in FIG. 9. Also, in the event that the predicted number of logical drives in use 30 minutes later is 128 or less (see the NO route in step B70), confirmation is made regarding whether or not the predicted number of logical drives in use 30 minutes later is 64 or less (step B90).

In the event that the predicted number of logical drives in use 30 minutes later is 65 or more (see the NO route in step B90), the flow transitions to the processing of step A50 in FIG. 9. Also, in the event that the predicted number of logical drives in use 30 minutes later is 64 or less (see the YES route in step B90), the first decrease flag is set to 1 (step B100) and then the flow transitions to the processing of step A50 in FIG. 9.

Also, in the event that the number of ICPs 150 currently running is not two (see the NO route in step B60), next, confirmation is made regarding whether or not the number of ICPs 150 currently running is three (step B110).

In the event that the number of ICPs 150 currently running is three (see the YES route in step B110), the number of processing units predicting unit 12 compares the value of “predicted number of units in use 30 minutes later” read out from the logical drive usage prediction information 15 with the maximum logical drive configuration value (192) at the time of three ICPs 150 read out from the ICP configuration changing threshold value information 16. That is to say, confirmation is made regarding whether or not the predicted number of logical drives in use 30 minutes later is 193 or more (step B120).

In the event that the predicted number of logical drives in use 30 minutes later is 193 or more (see the YES route in step B120), the first increase flag is set to 1 (step B130) and then the flow transitions to the processing of step A50 in FIG. 9. Also, in the event that the predicted number of logical drives in use 30 minutes later is 192 or less (see the NO route in step B120), confirmation is made regarding whether or not the predicted number of logical drives in use 30 minutes later is 128 or less (step B140).

In the event that the predicted number of logical drives in use 30 minutes later is 129 or more (see the NO route in step N140), the flow transitions to the processing of step A50 in FIG. 9. Also, in the event that the predicted number of logical drives in use 30 minutes later is 128 or less (see the YES route in step B140), the first decrease flag is set to 1 (step B150) and then the flow transitions to the processing of step A50 in FIG. 9.

Also, in the event that the number of ICPs 150 currently running is not three (see the NO route in step B110), next, confirmation is made regarding whether or not the number of ICPs 150 currently running is four (step B160).

In the event that the number of ICPs 150 currently running is four (see the YES route in step B160), the number of processing units predicting unit 12 compares the value of “predicted number of units in use 30 minutes later” read out from the logical drive usage prediction information 15 with the maximum logical drive configuration value (192) at the time of three ICPs 150 read out from the ICP configuration changing threshold value information 16. That is to say, confirmation is made regarding whether or not the predicted number of logical drives in use 30 minutes later is 192 or less (step B170).

In the event that the predicted number of logical drives in use 30 minutes later is 192 or less (see the YES route in step B170), the first decrease flag is set to 1 (step B180) and then the flow transitions to the processing of step A50 in FIG. 9. Also, in the event that the event that the number of ICPs 150 currently running is not four (see the NO route in step B160), or the predicted number of logical drives in use 30 minutes later is 193 or more (see the NO route in step B170), the flow transitions to the processing of step A50 in FIG. 9.

As described above, the number of processing units predicting unit 12 determines the number of ICPs 150 in demand, based on the “number of ICPs” at the current point-in-time, the “predicted number of units in use 30 minutes later”, and the ICP configuration changing threshold value information 16. In the event that the number of ICPs 150 in demand is greater than the number currently running, the number of processing units predicting unit 12 sets the first increase flag to 1 (ICP increase prediction), while in the event that the number of ICPs 150 in demand is smaller than the number currently running, the number of processing units predicting unit 12 sets the first decrease flag to 1 (ICP decrease prediction).

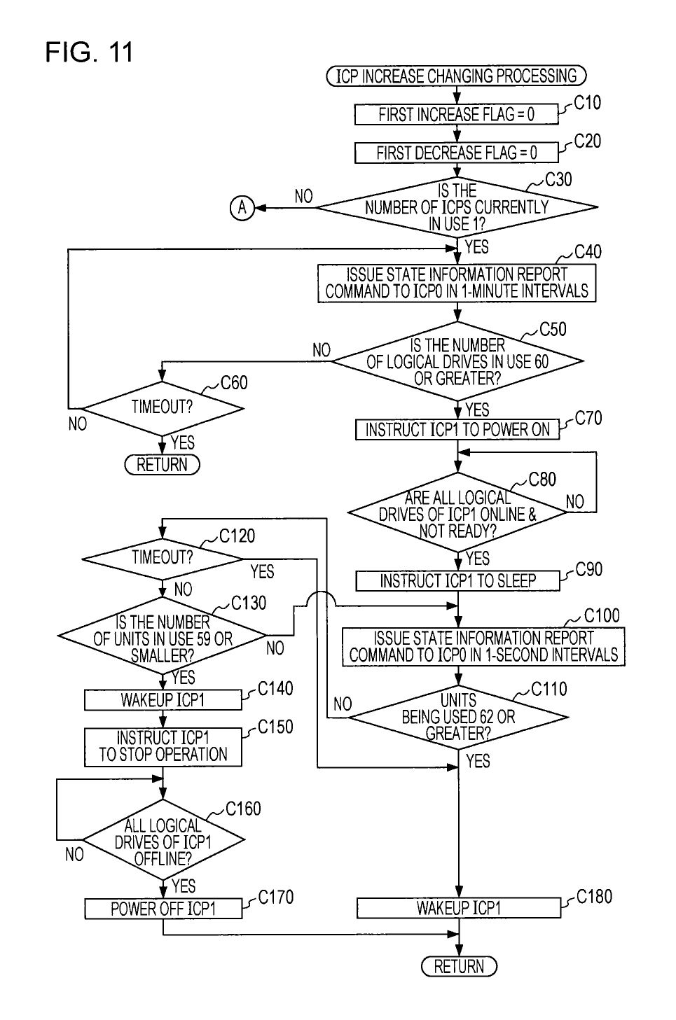

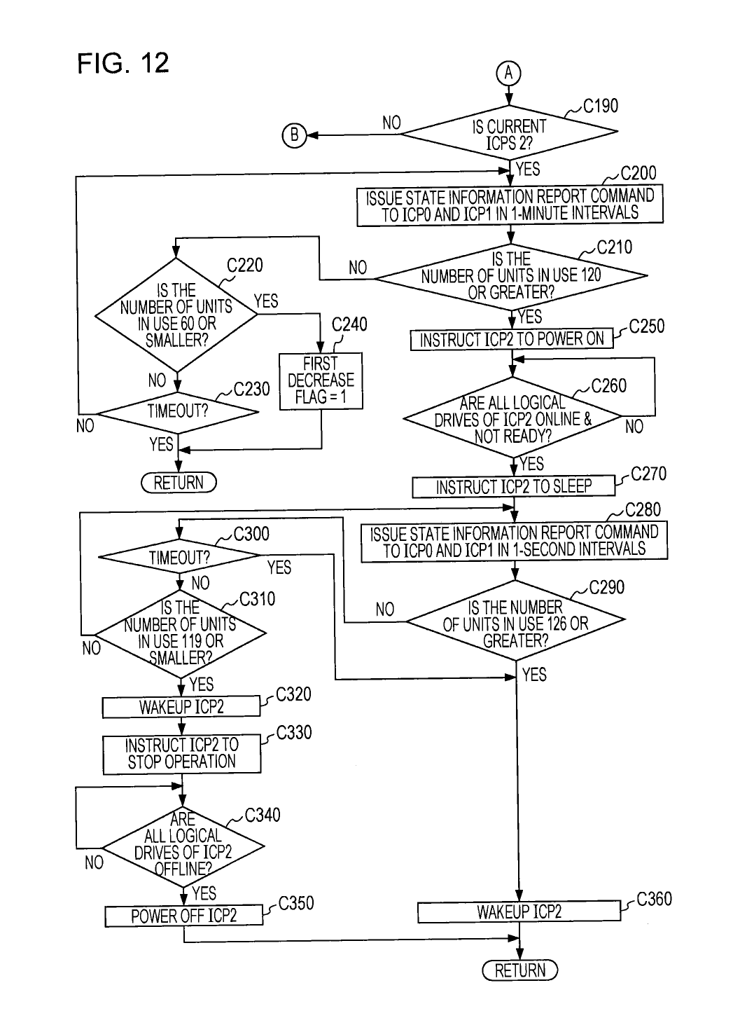

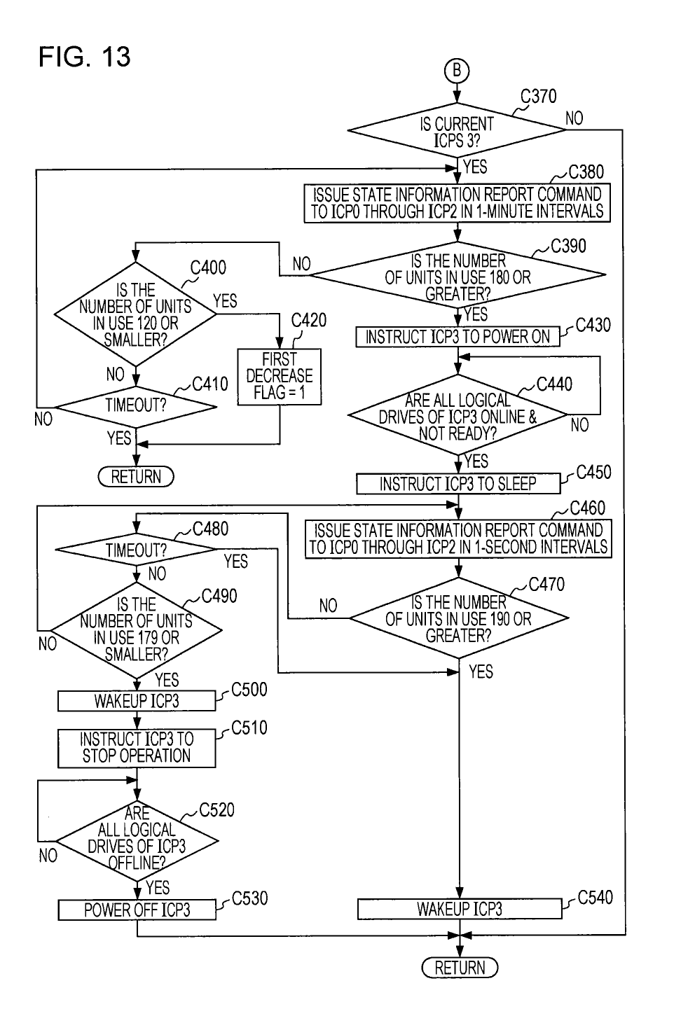

Next, the ICP increase change processing technique (see steps A100 and A150 in FIG. 9) with the virtual tape system 1 as an example of the embodiment will be described following the method illustrated in FIGS. 11 through 13 (steps S10 through C540). Steps C10 through C180 are illustrated in FIG. 11, steps C190 through C360 are illustrated in FIG. 12, and steps C370 through C540 are illustrated in FIG. 13. Note that with this example, the number of processing units predicting unit 12 performs increase/decrease prediction determination of the ICPs 150 based on the ICP configuration changing threshold value information 16 exemplarily illustrated in FIG. 7.

First, after having initialized the first increase flag and first decrease flag by setting each to 0 (steps C10 and C20), the control unit 13 references the logical drive usage prediction information 15, for example, thereby confirming whether or not the number of ICPs 150 currently running is one (step C30).

In the event that the number of ICPs 150 currently running is one (see the YES route in step C30), the collecting unit 10 issues a state information report command to the ICP0 every second predetermined interval (1 minute with the present example) (step C40). That is to say, in the event that an increase tendency of ICPs 150 is predicted, the operating state information of all ICPs 150 is collected at 1-minute intervals until the number of logical drives reaches 60, which is the first threshold value serving as the lower limit value of the ICP increase changing threshold value when the number of ICPs 150 is one (1-unit configuration).

The control unit 13 reads out the number of logical drives being used at the current point-in-time from the logical drive usage prediction information 15, for example. The control unit 13 compares this value of logical drives in use with the first threshold value of the ICP increase configuration changing threshold (60) in the event that the number of ICPs 150 read out from the ICP configuration changing threshold value information 16 is one. That is to say, confirmation is made regarding whether or not the number of logical drives in use is 60 or more (step C50).

In the event that the number of logical drives in use is less than 60 (see the NO route in step C50), next, confirmation is made regarding whether or not the amount of time elapsed after the collecting unit 10 has issued the state information report command in step A10 in FIG. 9 has reached the pre-stipulated timeout determination time, thereby determining whether a timeout has occurred (step C60). In the event that the amount of time elapsed after the collecting unit 10 has issued the state information report command has reached the pre-stipulated timeout determination time, meaning that a timeout has occurred (see the YES route in step C60), the flow transitions to the processing of steps A110 or A70 in FIG. 9. On the other hand, in the event that this is not a timeout (see the NO route in step C60), the flow returns to step C40.

Note that this timeout determining time is shorter than the above-described first predetermined interval (30 minutes with the embodiment), and is 29 minutes, for example. Accordingly, timeout detection of the time elapsed from the collecting unit 10 having issued the state information report command is performed with a timeout determination time smaller than the first predetermined interval is performed, and the processing is forcibly returned to the method in FIG. 9. Accordingly, the processing relating to the earlier state information report command can be completed before the collecting unit 10 issues the next state information report command, thereby improving reliability.

Also, in the event that the number of logical drives in use is 60 or more (see the YES route in step C50), the control unit 13 gives a power-on instruction for the ICP1 to the PDU 132 (step C70). The control unit 13 stands by until all logical drives of the ICP1 are in an ONLINE and NOT READY state (step C80).

Upon all logical drives of the ICP1 being in an ONLINE and NOT READY state (see the YES route in step C80), the control unit 13 issues a sleep instruction to the ICP1 (step C90). The collecting unit 10 issues a state information report command to the at ICP0 the third predetermined interval (1-second intervals with this example) (step C100).

The control unit 13 reads out the number of logical drives in use at the current point-in-time, from the logical drive usage prediction information 15, for example. The control unit 13 compares this value of the number of units in use with the second threshold value of the ICP increase configuration changing threshold value (62) in the event that the number of ICPs 150 is one, read out from the ICP configuration changing threshold value information 16. That is to say, confirmation is made regarding whether or not the number of logical drives in use is 62 or more (step C110).

In the event that the number of logical drives in use is 62 or more (see the YES route in step C110), a wakeup command is issued to the ICP1 (step C180), and the ICP1 is placed in a running state. That is to say, the configuration of ICPs 150 is changed to a 2-unit configuration. Subsequently, the flow transitions to the processing of steps A110 or A70 in FIG. 9.

On the other hand, in the event that the number of logical drives in use is less than 62 (see the NO route in step C110), confirmation is made regarding whether or not the time elapsed since the collecting unit 10 has issued the state information report command in step A10 in FIG. 9 has reached the pre-stipulated timeout determination time, thereby determining whether or not a timeout has occurred (step C120).

In the event that the timeout determination time has elapsed after the collecting unit 10 has issued the state information report command, i.e., in the event that a timeout has occurred (see the YES route in step C120), the flow transitions to step C180.

Also, in the event that a timeout has not occurred (see the NO route in step C120), the control unit 13 next compares the number of logical drives in use at the current point-in-time with the value of the first threshold value (60) of the ICP increase configuration changing threshold value in the event that the number of ICPs 150 is one, read out from the ICP configuration changing threshold value information 16. That is to say, determination is made regarding whether or not the number of logical drives in use is 59 or less (step C130).

In the event that the number of logical drives in use is 60 or more (see the NO route in step C130), the flow returns to step C100. On the other hand, in the event that the number of logical drives in use is 59 or less (see the YES route in step C130), the operation state monitoring being performed as to the ICP 150, i.e., issuing of the state information report command at 1-second intervals, is stopped. The ICP1 is then stopped and the configuration is changed to a 1-unit configuration of the ICP0. That is to say, after a wakeup command is issued to the ICP1 (step C140), an operation stop instruction is issued to the ICP1 (step C150).

The control unit 13 stands by until all logical drives of the ICP1 are in an OFFLINE state (step C160).

Upon all logical drives of the ICP1 being in an OFFLINE state (see the YES route in step C160), in step C170 the control unit 13 turns the electric power to the ICP1 off (POWER OFF). Subsequently, the flow transitions to the processing of steps A110 or A70 in FIG. 9.

Thus, in the event that the number of logical drives does not reach 60, which is the first threshold value of the ICP increase configuration changing threshold value for one ICP 150, despite the ICP increase prediction made by the number of processing units predicting unit 12, the number of ICPs 150 is not increased.

Also, in the event that the number of ICPs 150 currently running is not one (see the NO route in step C30), next, in step C190 in FIG. 12, confirmation is made regarding whether or not the current number of ICPs 150 running is two.

In the event that the number of ICPs 150 currently running is two (see the YES route in step C190), the collecting unit 10 issues a state information report command to the ICP0 and ICP1 every second predetermined interval (1 minute with the present example) (step C200). That is to say, in the event that an increase tendency of ICPs 150 is predicted, the operating state information of all ICPs 150 is collected at 1-minute intervals until the number of logical drives reaches 120, which is the first threshold value serving as the lower limit value of the ICP increase change value when the number of ICPs 150 is two (2-unit configuration).

The control unit 13 reads out the number of logical drives being used at the current point-in-time from the logical drive usage prediction information 15, for example. The control unit 13 compares this value of logical drives in use with the first threshold value of the ICP increase configuration changing threshold (120) in the event that the number of ICPs 150 read out from the ICP configuration changing threshold value information 16 is two. That is to say, confirmation is made regarding whether or not the number of logical drives in use is 120 or more (step C210).

In the event that the number of logical drives in use is less than 120 (see the NO route in step C210), next, the number of logical drives in use is compared with the value (60) of the first threshold value of the ICP decrease confirmation changing threshold when the number of ICPs 150 is two, read out from the ICP configuration changing threshold value information 16 (step C220). In the event that the number of logical drives in use is 60 or less (see the YES route in step C220), the number of ICPs 150 in demand is one, so 1 is set to the first decrease flag (step C240). That is to say, in the event that the number of logical drives in use is 60 or less, which is the first threshold value of the ICP decrease confirmation changing threshold when the number of ICPs 150 is two, ICP 150 decrease changing is performed. Subsequently, the flow transitions to the processing of steps A110 or A70 in FIG. 9.

Also, in the event that the number of logical drives in use is 61 or more (see the NO route in step C220), next, confirmation is made regarding whether or not the amount of time elapsed after the collecting unit 10 has issued in step A10 in FIG. 9 has reached the pre-stipulated timeout determination time, thereby determining whether a timeout has occurred (step C230). In the event that the amount of time elapsed after the collecting unit 10 has issued has reached the pre-stipulated timeout determination time, meaning that a timeout has occurred (see the YES route in step C230), the flow transitions to the processing of steps A110 or A70 in FIG. 9. On the other hand, in the event that this is not a timeout (see the NO route in step C230), the flow returns to step C200.

Also, in the event that the number of logical drives in use is 120 or more (see the YES route in step C210), the control unit 13 gives a power-on instruction for the ICP2 to the PDU 132 (step C250). The control unit 13 stands by until all logical drives of the ICP2 are in an ONLINE and NOT READY state (step C260).

Upon all logical drives of the ICP2 being in an ONLINE and NOT READY state (see the YES route in step C260), the control unit 13 issues a sleep instruction to the ICP2 (step C270). The collecting unit 10 issues a state information report command to the ICP0 and ICP1 at the third predetermined interval (1-second intervals with this example) (step C280).

The control unit 13 reads out the number of logical drives in use at the current point-in-time, from the logical drive usage prediction information 15, for example. The control unit 13 compares this value of the number of units in use with the value of the second threshold value of the ICP increase configuration changing threshold value (126) in the event that the number of ICPs 150 is two, read out from the ICP configuration changing threshold value information 16. That is to say, confirmation is made regarding whether or not the number of logical drives in use is 126 or more (step C290).

In the event that the number of logical drives in use is 126 or more (see the YES route in step C290), a wakeup command is issued to the ICP2 (step C360), and the ICP2 is placed in a running state. That is to say, the configuration of ICPs 150 is changed to a 3-unit configuration. Subsequently, the flow transitions to the processing of steps A110 or A70 in FIG. 9.

On the other hand, in the event that the number of logical drives in use is less than 126 (see the NO route in step C290), confirmation is made regarding whether or not the time elapsed since the collecting unit 10 has issued the state information report command in step A10 in FIG. 9 has reached the pre-stipulated timeout determination time, thereby determining whether or not a timeout has occurred (step C300).

In the event that the timeout determination time has elapsed after the collecting unit 10 has issued the state information report command, i.e., in the event that a timeout has occurred (see the YES route in step C300), the flow transitions to step C360.

Also, in the event that a timeout has not occurred (see the NO route in step C300), the control unit 13 next compares the number of logical drives in use at the current point-in-time with the value of the first threshold value (120) of the ICP increase configuration changing threshold value in the event that the number of ICPs 150 is two, read out from the ICP configuration changing threshold value information 16. That is to say, determination is made regarding whether or not the number of logical drives in use is 119 or less (step C310).

In the event that the number of logical drives in use is 120 or more (see the NO route in step C310), the flow returns to step C280. On the other hand, in the event that the number of logical drives in use is 119 or less (see the YES route in step C310), the operation state monitoring being performed as to the ICPs 150, i.e., issuing of the state information report command at 1-second intervals, is stopped. The ICP2 is then stopped and the configuration is changed to a 2-unit configuration of the ICP0 and ICP1. That is to say, after a wakeup command is issued to the ICP2 (step C320), an operation stop instruction is issued to the ICP2 (step C330).

The control unit 13 stands by until all logical drives of the ICP2 are in an OFFLINE state (step C340).

Upon all logical drives of the ICP2 being in an OFFLINE state (see the YES route in step C340), in step C350 the control unit 13 turns the electric power to the ICP2 off (POWER OFF). Subsequently, the flow transitions to the processing of steps A110 or A70 in FIG. 9.

Thus, in the event that the number of logical drives in use does not reach 120, which is the first threshold value of the ICP increase configuration changing threshold value for two ICPs 150, despite the ICP increase prediction made by the number of processing units predicting unit 12, the number of ICPs 150 is not increased.

On the other hand, in the event that the number of logical drives in use reaches 60 or less which is the first threshold value of the ICP decrease configuration changing threshold value for two ICPs 150, 1 is set to the first decrease flag so as to reduce the number of ICPs 150.

Also, in the event that the number of ICPs 150 currently running is not two (see the NO route in step C190), next, in step C370 in FIG. 13, confirmation is made regarding whether or not the current number of ICPs 150 running is three.

In the event that the number of ICPs 150 currently running is three (see the YES route in step C370), the collecting unit 10 issues a state information report command to the ICP0 through ICP2 every second predetermined interval (1 minute intervals with the present example) (step C380). That is to say, in the event that an increase tendency of ICPs 150 is predicted, the operating state information of all ICPs 150 is collected at 1-minute intervals until the number of logical drives reaches 180, which is the first threshold value serving as the lower limit value of the ICP increase change value when the number of ICPs 150 is three (3-unit configuration).

The control unit 13 reads out the number of logical drives being used at the current point-in-time from the logical drive usage prediction information 15, for example. The control unit 13 compares this value of logical drives in use with the first threshold value of the ICP increase configuration changing threshold (180) in the event that the number of ICPs 150 read out from the ICP configuration changing threshold value information 16 is three. That is to say, confirmation is made regarding whether or not the number of logical drives in use is 180 or more (step C390).

In the event that the number of logical drives in use is less than 180 (see the NO route in step C390), next, the value of the number of logical drives in use is compared with the value of the first threshold value (120) of the ICP decrease confirmation changing threshold when the number of ICPs 150 is three, read out from the ICP configuration changing threshold value information 16. That is to say confirmation is made regarding whether or not the number of logical drives in use is 120 or less (step C400). In the event that the number of logical drives in use is 120 or less (see the YES route in step C400), the number of ICPs 150 in demand is two or less, so 1 is set to the first decrease flag (step C420). That is to say, in the event that the number of logical drives in use is 120 or less, which is the first threshold value of the ICP decrease confirmation changing threshold when the number of ICPs 150 is three, ICP 150 decrease changing is performed. Subsequently, the flow transitions to the processing of steps A110 or A70 in FIG. 9.

Also, in the event that the number of logical drives in use is 121 or more (see the NO route in step C400), next, confirmation is made regarding whether or not the amount of time elapsed after the collecting unit 10 has issued the state information report command in step A10 in FIG. 9 has reached the pre-stipulated timeout determination time, thereby determining whether a timeout has occurred (step C410). In the event that the amount of time elapsed after the collecting unit 10 has issued the state information report command has reached the pre-stipulated timeout determination time, meaning that a timeout has occurred (see the YES route in step C410), the flow transitions to the processing of steps A110 or A70 in FIG. 9. On the other hand, in the event that this is not a timeout (see the NO route in step C410), the flow returns to step C380.

Also, in the event that the number of logical drives in use is 180 or more (see the YES route in step C390), the control unit 13 gives a power-on instruction for the ICP3 to the PDU 132 (step C430). The control unit 13 stands by until all logical drives of the ICP3 are in an ONLINE and NOT READY state (step C440).

Upon all logical drives of the ICP3 being in an ONLINE and NOT READY state (see the YES route in step C440), the control unit 13 issues a sleep instruction to the ICP3 (step C450). The collecting unit 10 issues a state information report command to the ICP0, ICP1, and ICP2 at the third predetermined interval (1-second intervals with this example) (step C460).

The control unit 13 reads out the number of logical drives in use at the current point-in-time, from the logical drive usage prediction information 15, for example. The control unit 13 compares this value of the number of units in use with the second threshold value of the ICP increase configuration changing threshold value (190) in the event that the number of ICPs 150 is three, read out from the ICP configuration changing threshold value information 16. That is to say, confirmation is made regarding whether or not the number of logical drives in use is 190 or more (step C470).

In the event that the number of logical drives in use is 190 or more (see the YES route in step C470), a wakeup command is issued to the ICP3 (step C540), and the ICP3 is placed in a running state. That is to say, the configuration of ICPs 150 is changed to a 4-unit configuration. Subsequently, the flow transitions to the processing of steps A110 or A70 in FIG. 9.

On the other hand, in the event that the number of logical drives in use is less than 190 (see the NO route in step C470), confirmation is made regarding whether or not the time elapsed since the collecting unit 10 has issued the state information report command in step A10 in FIG. 9 has reached the pre-stipulated timeout determination time, thereby determining whether or not a timeout has occurred (step C480).

In the event that the timeout determination time has elapsed after the collecting unit 10 has issued the state information report command, i.e., in the event that a timeout has occurred (see the YES route in step C480), the flow transitions to step C540.

Also, in the event that a timeout has not occurred (see the NO route in step C480), the control unit 13 next compares the number of logical drives in use at the current point-in-time with the value of the first threshold value (180) of the ICP increase configuration changing threshold value in the event that the number of ICPs 150 is three, read out from the ICP configuration changing threshold value information 16. That is to say, determination is made regarding whether or not the number of logical drives in use is 179 or less (step C490).

In the event that the number of logical drives in use is 180 or more (see the NO route in step C490), the flow returns to step C460. On the other hand, in the event that the number of logical drives in use is 179 or less (see the YES route in step C490), the operation state monitoring being performed as to the ICPs 150, i.e., issuing of the state information report command at 1-second intervals, is stopped. The ICP3 is then stopped and the configuration is changed to a 3-unit configuration of the ICP0 through ICP2. That is to say, after a wakeup command is issued to the ICP3 (step C500), an operation stop instruction is issued to the ICP3 (step C510).

The control unit 13 stands by until all logical drives of the ICP3 are in an OFFLINE state (step C520).

Upon all logical drives of the ICP2 being in an OFFLINE state (see the YES route in step C520), in step C530 the control unit 13 turns the electric power to the ICP3 off (POWER OFF). Subsequently, the flow transitions to the processing of steps A110 or A70 in FIG. 9.

Also, in the event that the number of ICPs 150 currently running is not three as well (see the NO route in step C370), the flow transitions to the processing of steps A110 or A70 in FIG. 9.

Thus, in the event that the number of logical drives does not reach 180, which is the first threshold value of the ICP increase configuration changing threshold value for three ICPs 150, despite the ICP increase prediction made by the number of processing units predicting unit 12, the number of ICPs 150 is not increased.

On the other hand, in the event that the number of logical drives reaches 120 or less which is the first threshold value of the ICP decrease configuration changing threshold value for three ICPs 150, 1 is set to the first decrease flag so as to reduce the number of ICPs 150.

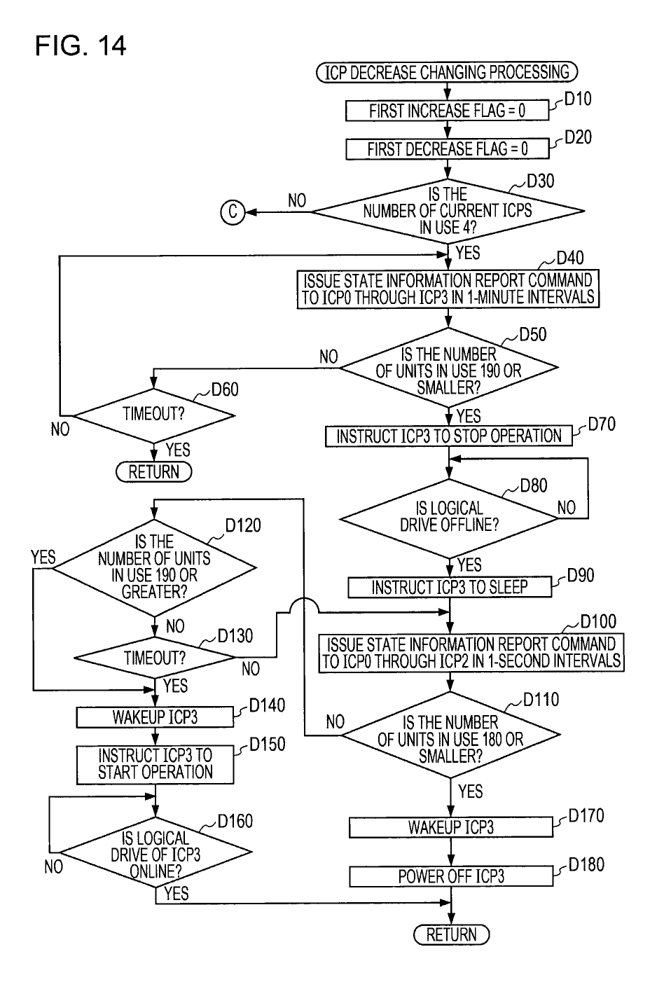

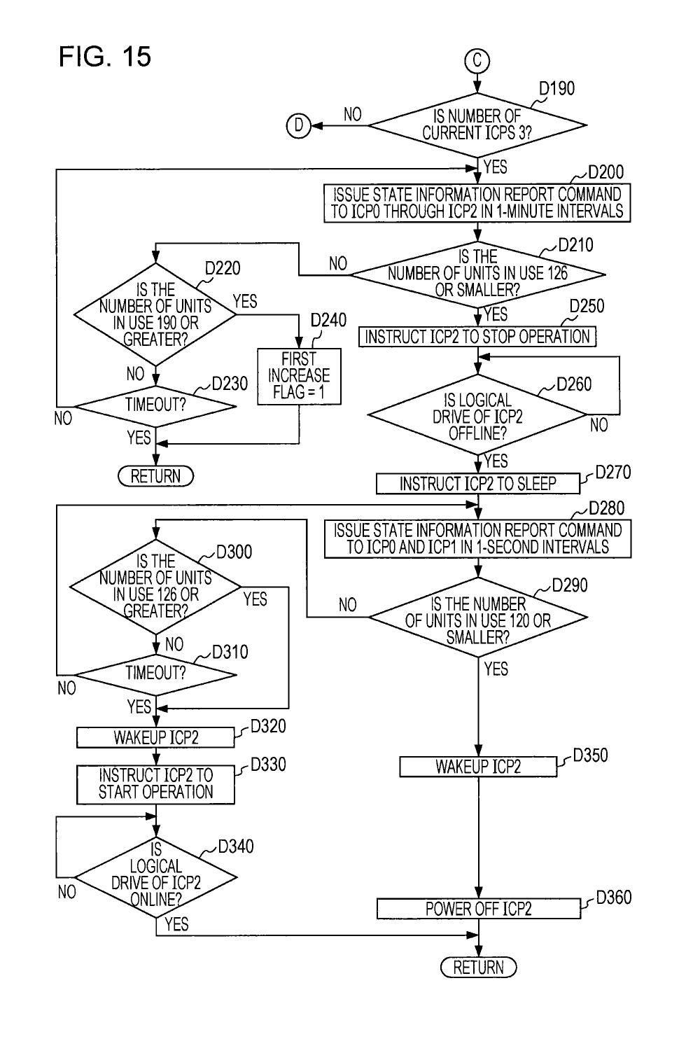

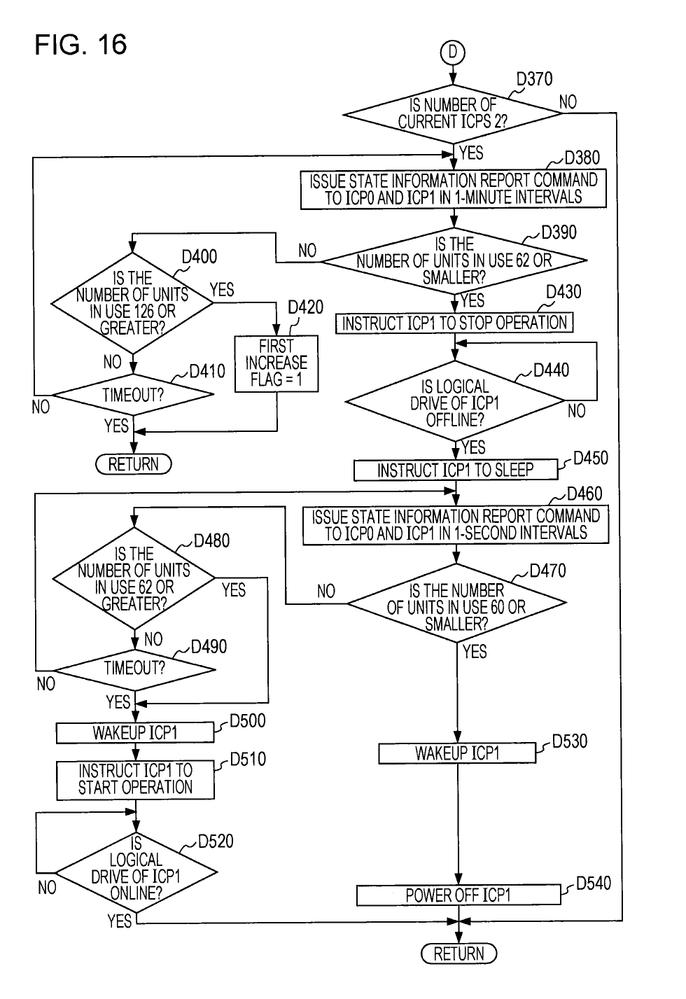

Next, the ICP decrease change processing technique (see steps A120 and A130 in FIG. 9) with the virtual tape system 1 as an example of the embodiment will be described following the method illustrated in FIGS. 14 through 16 (steps D10 through D540). Steps D10 through D180 are illustrated in FIG. 14, steps D190 through D360 are illustrated in FIG. 15, and steps D370 through D540 are illustrated in FIG. 16. Note that with this example, the number of processing units predicting unit 12 performs increase/decrease prediction determination of the ICPs 150 based on the ICP configuration changing threshold value information 16 exemplarily illustrated in FIG. 7.

First, after having initialized the first increase flag and first decrease flag by setting each to 0 (steps D10 and D20), the control unit 13 references the logical drive usage prediction information 15 for example, thereby confirming whether or not the number of ICPs 150 currently running is four (step D30).

In the event that the number of ICPs 150 currently running is four (see the YES route in step D30), the collecting unit 10 issues a state information report command to the ICP0 through ICP3 every second predetermined interval (1 minute with the present example) (step D40).

The control unit 13 reads out the number of logical drives being used at the current point-in-time from the logical drive usage prediction information 15, for example. The control unit 13 compares this value of logical drives in use with the first threshold value of the ICP decrease configuration changing threshold (190) in the event that the number of ICPs 150 read out from the ICP configuration changing threshold value information 16 is four. That is to say, confirmation is made regarding whether or not the number of logical drives in use is 190 or more (step D50).

In the event that the number of logical drives in use is 191 or more (see the NO route in step D50), next, confirmation is made regarding whether or not the amount of time elapsed after the collecting unit 10 has issued in step A10 in FIG. 9 has reached the pre-stipulated timeout determination time, thereby determining whether a timeout has occurred (step D60). In the event that the amount of time elapsed after the collecting unit 10 has issued has reached the pre-stipulated timeout determination time, meaning that a timeout has occurred (see the YES route in step D60), the flow transitions to the processing of steps A70 or A140 in FIG. 9. On the other hand, in the event that this is not a timeout (see the NO route in step D60), the flow returns to step D40.

Also, in the event that the number of logical drives in use is 190 or less (see the YES route in step D50), the control unit 13 gives an operation stop instruction for the ICP3 to the PDU 132 (step D70).

Upon receiving the operation stop instruction, the ICP 150 immediately sets NOT READY logical drives to OFFLINE. Also, READY logical drives continue to operate in a READY state until an unload command is received from the host device 200, and go OFFLINE at the point that the unload command is received. After having configured that all logical drives on the ICP 150 (64 with the embodiment) have gone OFFLINE, the PCU 120 is notified that operations of the ICP 150 have stopped.

The control unit 13 stands by until all logical drives of the ICP3 are in an OFFLINE state (step D80).

Upon all logical drives of the ICP3 being in an OFFLINE state (see the YES route in step D80), the control unit 13 issues a sleep instruction to the ICP3 (step D90). The collecting unit 10 issues a state information report command to the ICP0 through ICP2 at the third predetermined interval (1-second intervals with this example) (step D100).

The control unit 13 reads out the number of logical drives in use at the current point-in-time, from the logical drive usage prediction information 15, for example. The control unit 13 compares this value of the number of units in use with the first threshold value of the ICP decrease configuration changing threshold value (180, which is the lower limit value) in the event that the number of ICPs 150 is four, read out from the ICP configuration changing threshold value information 16. That is to say, confirmation is made regarding whether or not the number of logical drives in use is 180 or less (step D110).

In the event that the number of logical drives in use is 180 or less(see the YES route in step D110), a wakeup command is issued to the ICP3 (step D170), and the ICP3 is powered off (POWER OFF) (step D180). That is to say, the configuration of ICPs 150 is changed to a 3-unit configuration. Subsequently, the flow transitions to the processing of steps A70 or A140 in FIG. 9.

On the other hand, in the event that the number of logical drives in use is 181 or greater (see the NO route in step D110), the control unit 13 next compares the number of logical drives in use at the current point-in-time with the value of the second threshold value (190, which is the upper limit value) of the ICP decrease configuration changing threshold value in the event that the number of ICPs 150 is four, read out from the ICP configuration changing threshold value information 16. That is to say, determination is made regarding whether or not the number of logical drives in use is 190 or more (step D120).

In the event that the number of logical drives in use is 190 or less(see the NO route in step D120), confirmation is made regarding whether or not the time elapsed since the collecting unit 10 has issued the state information report command in step A10 in FIG. 9 has reached the pre-stipulated timeout determination time, thereby determining whether or not a timeout has occurred (step D130).

In the event that the timeout determination time has elapsed after the collecting unit 10 has issued the state information report command, i.e., in the event that a timeout has occurred (see the YES route in step D130), the control unit 13 issues a wakeup command to the ICP3 (step D140), and issues an operation start instruction for the ICP3 (step D150).

The control unit 13 stands by until all logical drives of the ICP3 are in an ONLINE and NOT READY state (step C160).

Upon all logical drives of the ICP3 being in an ONLINE and NOT READY state, and the configuration returns to the original 4-unit configuration of ICPs 150 (see the YES route in step C160), the flow then transitions to the processing of steps A70 or A140 in FIG. 9.

In the event that the number of logical drives in use is 190 or more (see the YES route in step D120), the flow advances to step D140.

Also, in the event that a timeout has not occurred (see the NO route in step D130), the flow transitions to step D100.

Thus, in the event that the number of logical drives does not decrease to 180 or lower, which is the first threshold value of the ICP decrease configuration changing threshold value for four ICPs 150, despite the ICP decrease prediction made by the number of processing units predicting unit 12, the number of ICPs 150 is not decreased.

Also, in the event that the number of ICPs 150 currently running is not four (see the NO route in step D30), next, in step D190 in FIG. 15, confirmation is made regarding whether or not the current number of ICPs 150 running is three.

In the event that the number of ICPs 150 currently running is three (see the YES route in step D190), the collecting unit 10 issues a state information report command to the ICP0 through ICP2 every second predetermined interval (1 minute with the present example) (step D200).

The control unit 13 reads out the number of logical drives being used at the current point-in-time from the logical drive usage prediction information 15, for example. The control unit 13 compares this value of logical drives in use with the second threshold value (upper limit value) of the ICP decrease configuration changing threshold (126) in the event that the number of ICPs 150 read out from the ICP configuration changing threshold value information 16 is three. That is to say, confirmation is made regarding whether or not the number of logical drives in use is 126 or less (step D210).

In the event that the number of logical drives in use is 127 or more (see the NO route in step D210), next, the value of logical drives in use is compared with the second threshold value (190) of the ICP increase configuration changing threshold in the event that the number of ICPs 150 read out from the ICP configuration changing threshold value information 16 is three. That is to say, confirmation is made regarding whether or not the number of logical drives in use is 190 or more (step D220). In the event that the number of logical drives in use is 190 or more (see the YES route in step D220), the number of ICPs 150 in demand is four, so the first increase flag is set to 1 (step D240). That is to say, in the event that the number of logical devices reaches 190, which is the second threshold value of the ICP increase configuration changing threshold value for three ICPs 150, despite the ICP prediction made by the number of processing units predicting unit 12, the number of ICPs 150 is increased. Subsequently, the flow transitions to the processing of steps A70 or A140 in FIG. 9.

Also, in the event that the number of logical drives in use is 190 or less (see the YES route in step D220), next, confirmation is made regarding whether or not the amount of time elapsed after the collecting unit 10 has issued in step A10 in FIG. 9 has reached the pre-stipulated timeout determination time, thereby determining whether a timeout has occurred (step D230). In the event that the amount of time elapsed after the collecting unit 10 has issued has reached the pre-stipulated timeout determination time, meaning that a timeout has occurred (see the YES route in step D230), the flow transitions to the processing of steps A70 or A140 in FIG. 9. On the other hand, in the event that this is not a timeout (see the NO route in step D230), the flow returns to step D200.

Also, in the event that the number of logical drives in use is 126 or less (see the YES route in step D210), the control unit 13 gives an operation stop instruction for the ICP2 to the PDU 132 (step D250). The control unit 13 stands by until all logical drives of the ICP2 are in an OFFLINE state (step D260).

Upon all logical drives of the ICP2 being in an OFFLINE state (see the YES route in step D260), the control unit 13 issues a sleep instruction to the ICP2 (step D270). The collecting unit 10 issues a state information report command to the ICP0 and ICP1 at the third predetermined interval (1-second intervals with this example) (step D280).

The control unit 13 reads out the number of logical drives in use at the current point-in-time, from the logical drive usage prediction information 15, for example. The control unit 13 compares this value of the number of units in use with the first threshold value (lower limit value) of the ICP decrease configuration changing threshold value (120) in the event that the number of ICPs 150 is three, read out from the ICP configuration changing threshold value information 16. That is to say, confirmation is made regarding whether or not the number of logical drives in use is 120 or less (step D290).

In the event that the number of logical drives in use is 120 or less (see the YES route in step D290), a wakeup command is issued to the ICP2 (step D350), and the ICP2 is powered off (POWER OFF) (step D360). That is to say, the configuration of ICPs 150 is changed to a 2-unit configuration. Subsequently, the flow transitions to the processing of steps A70 or A140 in FIG. 9.

On the other hand, in the event that the number of logical drives in use is 121 or greater (see the NO route in step D290), the control unit 13 next compares the number of logical drives in use at the current point-in-time with the value of the second threshold value (126, which is the upper limit value) of the ICP decrease configuration changing threshold value in the event that the number of ICPs 150 is three, read out from the ICP configuration changing threshold value information 16. That is to say, determination is made regarding whether or not the number of logical drives in use is 126 or more (step D300).

In the event that the number of logical drives in use is less than 126 (see the NO route in step D300), confirmation is made regarding whether or not the time elapsed since the collecting unit 10 has issued the state information report command in step A10 in FIG. 9 has reached the pre-stipulated timeout determination time, thereby determining whether or not a timeout has occurred (step D310).

In the event that the timeout determination time has elapsed after the collecting unit 10 has issued the state information report command, i.e., in the event that a timeout has occurred (see the YES route in step D310), the control unit 13 issues a wakeup command to the ICP2 (step D320), and issues an operation start instruction for the ICP2 (step D330).

The control unit 13 stands by until all logical drives of the ICP2 are in an ONLINE state (step D340).

Upon all logical drives of the ICP2 being in an ONLINE and NOT READY state, and the configuration returns to the original 3-unit configuration of ICPs 150 (see the YES route in step D340), the flow then transitions to the processing of steps A70 or A140 in FIG. 9.

Also, in the event that a timeout has not occurred (see the NO route in step D310) in step D310, the flow transitions to step D280.

Further, in the event that the number of logical drives in use is 126 or greater (see the YES route in step D300) in step D 300, the flow advances to step D320.

Thus, in the event that the number of logical drives does not decrease to 120 or lower, which is the first threshold value of the ICP decrease configuration changing threshold value for four ICPs 150, despite the ICP decrease prediction made by the number of processing units predicting unit 12, the number of ICPs 150 is not decreased.

Also, in the event that the number of logical drives in use is 190 or more, which is the second threshold value of the ICP increase configuration changing threshold value for three ICPs 150, the first increase flag is set to 1 so as to increase the number of ICPs 150.

Also, in the event that the number of ICPs 150 currently running is not three (see the NO route in step D190), next, in step D370 in FIG. 16, confirmation is made regarding whether or not the current number of ICPs 150 running is two.

In the event that the number of ICPs 150 currently running is two (see the YES route in step D370), the collecting unit 10 issues a state information report command to the ICP0 and ICP1 every second predetermined interval (1 minute with the present example) (step D380).

The control unit 13 reads out the number of logical drives being used at the current point-in-time from the logical drive usage prediction information 15, for example. The control unit 13 compares this value of logical drives in use with the second threshold value of the ICP decrease configuration changing threshold (62) in the event that the number of ICPs 150 read out from the ICP configuration changing threshold value information 16 is two. That is to say, confirmation is made regarding whether or not the number of logical drives in use is 62 or less (step D390).

In the event that the number of logical drives in use is 63 or more (see the NO route in step D390), next, the value of logical drives in use is compared with the second threshold value (126) of the ICP increase configuration changing threshold in the event that the number of ICPs 150 read out from the ICP configuration changing threshold value information 16 is two. That is to say, confirmation is made regarding whether or not the number of logical drives in use is 126 or more (step D400). In the event that the number of logical drives in use is 126 or more (see the YES route in step D400), the number of ICPs 150 in demand is three or less, so the first increase flag is set to 1 (step D420). That is to say, in the event that the number of logical devices is 126 or more, which is the second threshold value of the ICP increase configuration changing threshold value for two ICPs 150, the number of ICPs 150 is increased. Subsequently, the flow transitions to the processing of steps A70 or A140 in FIG. 9.

Also, in the event that the number of logical drives in use is 126 or less (see the NO route in step D400), next, confirmation is made regarding whether or not the amount of time elapsed after the collecting unit 10 has issued in step A10 in FIG. 9 has reached the pre-stipulated timeout determination time, thereby determining whether a timeout has occurred (step D410). In the event that the amount of time elapsed after the collecting unit 10 has issued has reached the pre-stipulated timeout determination time, meaning that a timeout has occurred (see the YES route in step D410), the flow transitions to the processing of steps A70 or A140 in FIG. 9. On the other hand, in the event that this is not a timeout (see the NO route in step D410), the flow returns to step D380.

Also, in the event that the number of logical drives in use is 62 or less (see the YES route in step D390), the control unit 13 gives an operation stop instruction for the ICP1 to the PDU 132 (step D430). The control unit 13 stands by until all logical drives of the ICP1 are in an OFFLINE state (step D440).

Upon all logical drives of the ICP1 being in an OFFLINE state (see the YES route in step D440), the control unit 13 issues a sleep instruction to the ICP1 (step D450). The collecting unit 10 issues a state information report command to the ICP0 and ICP1 at the third predetermined interval (1-second intervals with this example) (step D460).

The control unit 13 reads out the number of logical drives in use at the current point-in-time, from the logical drive usage prediction information 15, for example. The control unit 13 compares this value of the number of units in use with the first threshold value of the ICP decrease configuration changing threshold value (60) in the event that the number of ICPs 150 is two, read out from the ICP configuration changing threshold value information 16. That is to say, confirmation is made regarding whether or not the number of logical drives in use is 60 or less (step D470).

In the event that the number of logical drives in use is 60 or less(see the YES route in step D470), a wakeup command is issued to the ICP1 (step D530), and the ICP1 is powered off (POWER OFF) in step D540. Subsequently, the flow transitions to the processing of steps A70 or A140 in FIG. 9.

On the other hand, in the event that the number of logical drives in use is 61 or greater (see the NO route in step D470), the control unit 13 next compares the number of logical drives in use at the current point-in-time with the value of the second threshold value (62, which is the upper limit value) of the ICP decrease configuration changing threshold value in the event that the number of ICPs 150 is two, read out from the ICP configuration changing threshold value information 16. That is to say, confirmation is made regarding whether or not the number of logical drives in use is 62 or more (step D480).

In the event that the number of logical drives in use is less than 62 (see the NO route in step D480), confirmation is made regarding whether or not the time elapsed since the collecting unit 10 has issued the state information report command in step A10 in FIG. 9 has reached the pre-stipulated timeout determination time, thereby determining whether or not a timeout has occurred (step D490).

In the event that the timeout determination time has elapsed after the collecting unit 10 has issued the state information report command, i.e., in the event that a timeout has occurred (see the YES route in step D490), the control unit 13 issues a wakeup command to the ICP1 (step D500), and issues an operation start instruction for the ICP1 (step D510).

The control unit 13 stands by until all logical drives of the ICP1 are in an ONLINE state (step C520).

Upon all logical drives of the ICP1 being in an ONLINE and NOT READY state, and the configuration returns to the original 2-unit configuration of ICPs 150 (see the YES route in step C520), the flow then transitions to the processing of steps A70 or A140 in FIG. 9.

Also, in the event that a timeout has not occurred (see the NO route in step D490) in step D490, the flow transitions to step D460.

Further, in the event that the number of logical drives in use is 62 or greater (see the YES route in step D480) in step D480, the flow advances to step D500.

Also, in the event that the number of ICPs 150 currently running is not two (see the NO route in step D370), the flow transitions to the processing of steps A70 or A140 in FIG. 9.

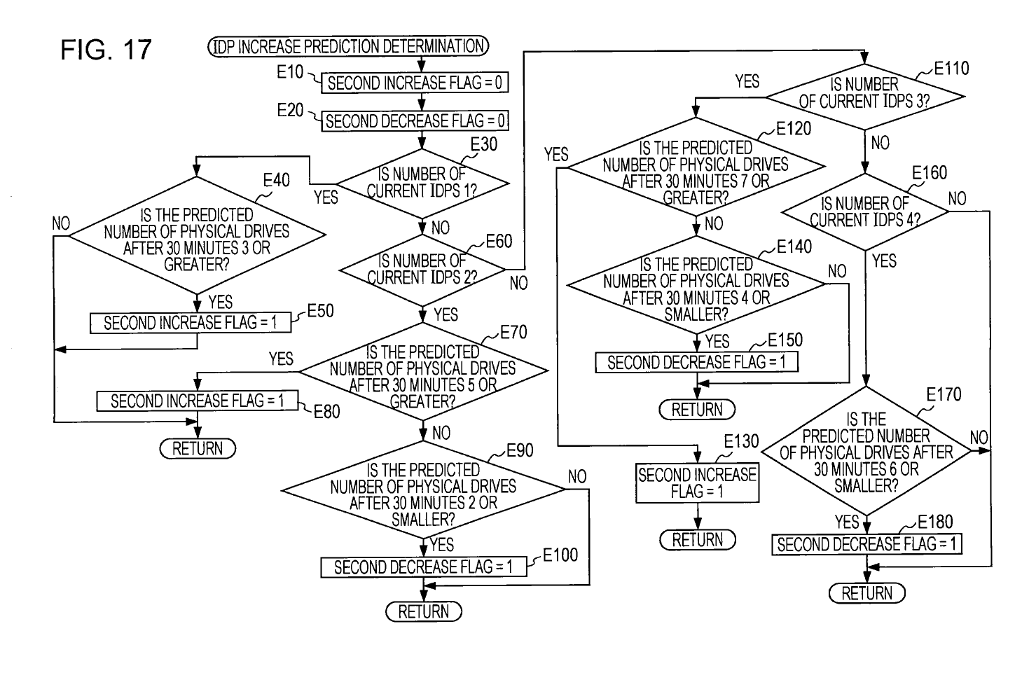

Next, the increase/decrease prediction determination technique of IDPs 170 by the number of processing units predicting unit 12 according to the virtual tape system 1 as an example of the embodiment (see step A70 in FIG. 9) will be described with reference to the method illustrated in FIG. 17 (steps E10 through E180). Note that with this example, the number of processing units predicting unit 12 performs increase/decrease prediction determination of IDPs 170 based on the IDP configuration changing threshold value information 18 exemplarily illustrated in FIG. 8.

First, the number of processing units predicting unit 12 initializes the second increase flag and second decrease flag by setting 0 thereto (Steps E10 and E20), and then confirms whether or not the number of IDPs 170 currently running is one, by referencing the physical drive usage prediction information 17, for example (step E30).

In the event that the number of IDPs 170 currently running is one (see the YES route in step E30), the number of processing units predicting unit 12 reads out the value for the “predicted number of units in use 30 minutes later” corresponding to the point-in-time from the physical drive usage prediction information 17.

The number of processing units predicting unit 12 compares the value of this “predicted number of units in use 30 minutes later” with the value of the maximum physical drive configuration when the number of IDPs 170 read out from the IDP configuration changing threshold value information 18 is one (2). That is to say, the number of processing units predicting unit 12 confirms whether or not the predicted number of physical drives in use 30 minutes later is three or more (step E40).

In the event that the predicted number of physical drives in use 30 minutes later is two or less (see the NO route in step E40), the flow transitions to the processing of step A80 in FIG. 9. On the other hand, in the event that the predicted number of physical drives in use 30 minutes later is three or more (see the YES route in step E40), 1 is set to the second increase flag (step E50), and the flow advances to the processing in step A80 in FIG. 9.

In the event that the number of IDPs 170 currently running is not one (see the NO route in step E30), next, whether or not the number of IDPs 170 currently running is two is confirmed (step E60).

In the event that the number of IDPs 170 currently running is two (see the YES route in step E60), the number of processing units predicting unit 12 compares the value of “predicted number of units in use 30 minutes later” read out from the physical drive usage prediction information 17 with the maximum physical drive configuration value (4) at the time of two IDPs 170 read out from the IDP configuration changing threshold value information 18. That is to say, confirmation is made regarding whether or not the predicted number of physical drives in use 30 minutes later is five or more (step E70).

In the event that the predicted number of physical drives in use 30 minutes later is five or more (see the YES route in step E70), the second increase flag is set to 1 (step E80) and then the flow transitions to the processing of step A80 in FIG. 9. Also, in the event that the predicted number of physical drives in use 30 minutes later is four or less (see the NO route in step E70), confirmation is made regarding whether or not the predicted number of physical drives in use 30 minutes later is two or less (step E90).

In the event that the predicted number of physical drives in use 30 minutes later is two or more (see the NO route in step N90), the flow transitions to the processing of step A80 in FIG. 9. Also, in the event that the predicted number of physical drives in use 30 minutes later is two or less (see the YES route in step E90), the second decrease flag is set to 1 (step E100) and then the flow transitions to the processing of step A80 in FIG. 9.

Also, in the event that the number of IDPs 170 currently running is not two (see the NO route in step E60), next, confirmation is made regarding whether or not the number of IDPs 170 currently running is three (step E110).

In the event that the number of IDPs 170 currently running is three (see the YES route in step E110), the number of processing units predicting unit 12 compares the value of “predicted number of units in use 30 minutes later” read out from the physical drive usage prediction information 17 with the maximum physical drive configuration value (6) at the time of three IDPs 170 read out from the IDP configuration changing threshold value information 18. That is to say, confirmation is made regarding whether or not the predicted number of physical drives in use 30 minutes later is seven or more (step E120).

In the event that the predicted number of physical drives in use 30 minutes later is seven or more (see the YES route in step E120), the second increase flag is set to 1 (step E130) and then the flow transitions to the processing of step A80 in FIG. 9. Also, in the event that the predicted number of physical drives in use 30 minutes later is six or less (see the NO route in step E120), confirmation is made regarding whether or not the predicted number of physical drives in use 30 minutes later is four or less (step E140).

In the event that the predicted number of physical drives in use 30 minutes later is five or more (see the NO route in step N140), the flow transitions to the processing of step A80 in FIG. 9. Also, in the event that the predicted number of physical drives in use 30 minutes later is four or less (see the YES route in step E140), the first decrease flag is set to 1 (step E150) and then the flow transitions to the processing of step A80 in FIG. 9.

Also, in the event that the number of IDPs 170 currently running is not three (see the NO route in step E110), next, confirmation is made regarding whether or not the number of IDPs 170 currently running is four (step E160).

In the event that the number of IDPs 170 currently running is four (see the YES route in step E160), the number of processing units predicting unit 12 compares the value of “predicted number of units in use 30 minutes later” read out from the physical drive usage prediction information 17 with the maximum physical drive configuration value (8) at the time of three IDPs 170 read out from the IDP configuration changing threshold value information 18. That is to say, confirmation is made regarding whether or not the predicted number of physical drives in use 30 minutes later is six or less (step E170).

In the event that the predicted number of physical drives in use 30 minutes later is six or less (see the YES route in step E170), the second decrease flag is set to 1 (step E180) and then the flow transitions to the processing of step A80 in FIG. 9. Also, in the event that the event that the number of IDPs 170 currently running is not four (see the NO route in step E160), or the predicted number of physical drives in use 30 minutes later is seven or more (see the NO route in step E170), the flow transitions to the processing of step A80 in FIG. 9.

As described above, the number of processing units predicting unit 12 determines the number of IDPs 170 in demand, based on the “number of IDPs 170” at the current point-in-time, the “predicted number of units in use 30 minutes later”, and the IDP configuration changing threshold value information 18. In the event that the number of IDPs 170 in demand is greater than the number currently running, the number of processing units predicting unit 12 sets the second increase flag to 1 (IDP increase prediction), while in the event that the number of IDPs 170 in demand is smaller than the number currently running, the number of processing units predicting unit 12 sets the second decrease flag to 1 (IDP decrease prediction).

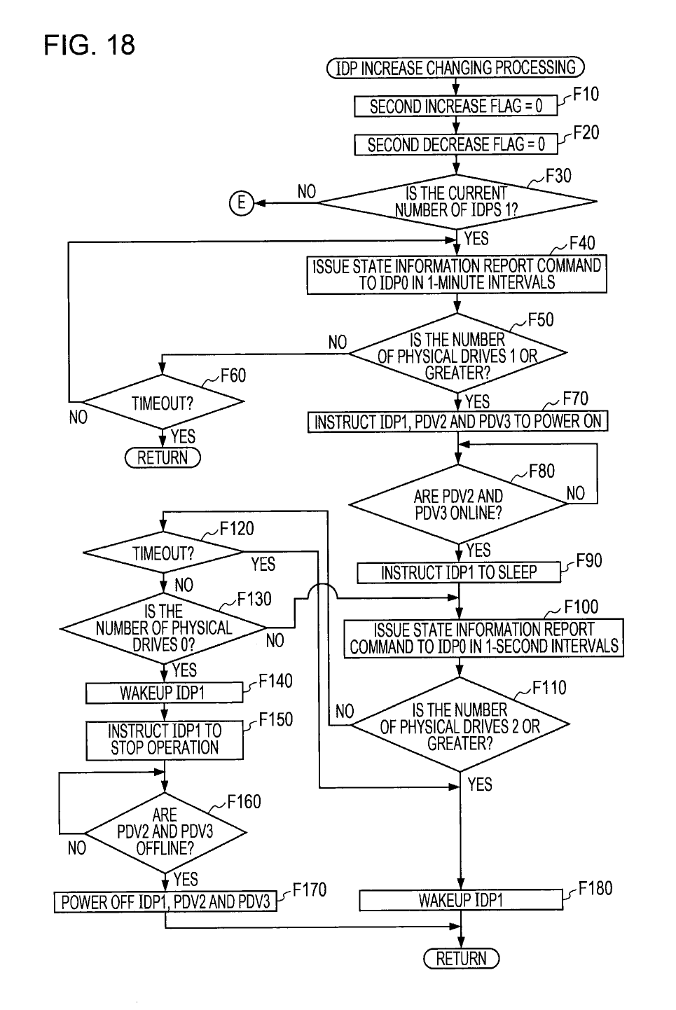

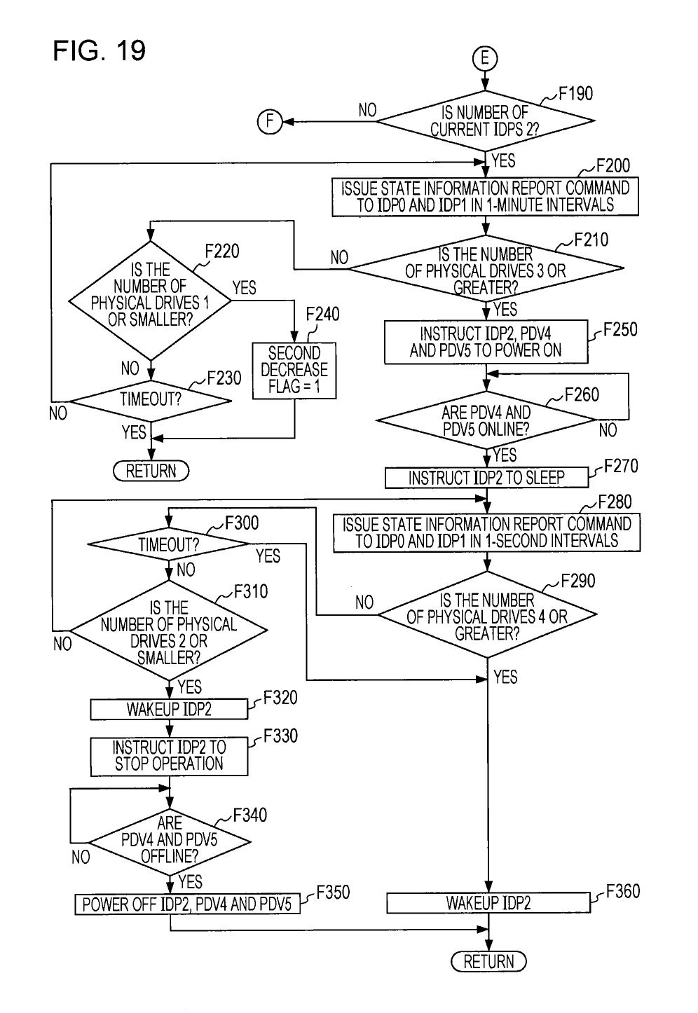

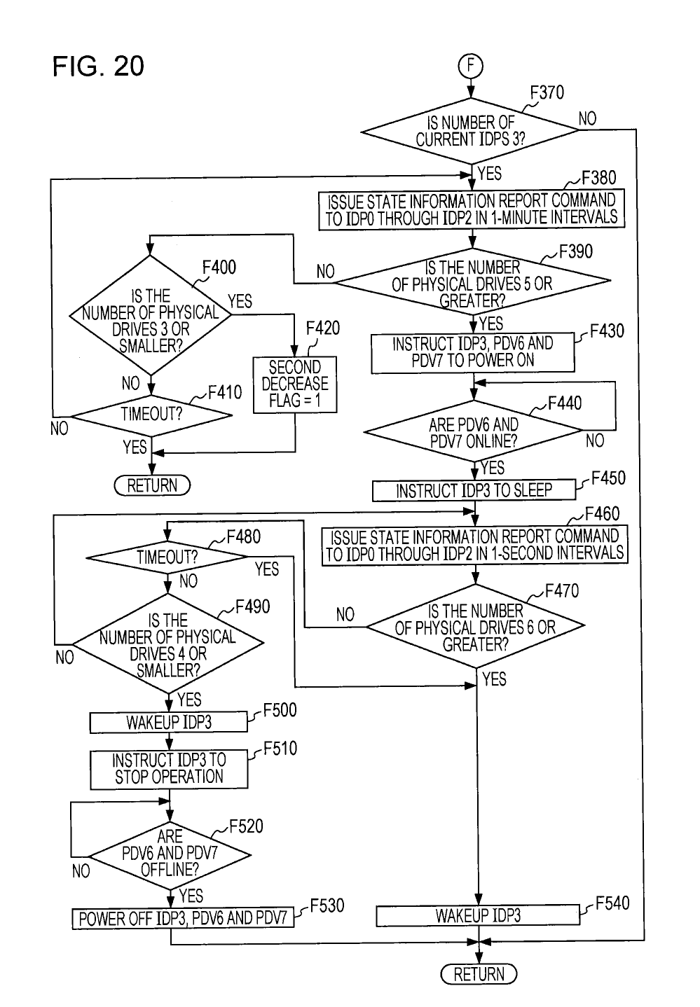

Next, the IDP increase change processing technique (see steps A160 and A210 in FIG. 9) with the virtual tape system 1 as an example of the embodiment will be described following the method illustrated in FIGS. 18 through 20 (steps F10 through F540). Steps F10 through F180 are illustrated in FIG. 18, steps F190 through F360 are illustrated in FIG. 19, and steps F370 through F540 are illustrated in FIG. 20. Note that with this example, the number of processing units predicting unit 12 performs increase/decrease prediction determination of the IDPs 170 based on the IDP configuration changing threshold value information 18 exemplarily illustrated in FIG. 8.

First, after having initialized the second increase flag and second decrease flag by setting each to 0 (steps F10 and F20), the control unit 13 references the physical drive usage prediction information 17 for example, thereby confirming whether or not the number of IDPs 170 currently running is one (step F30).

In the event that the number of IDPs 170 currently running is one (see the YES route in step F30), the collecting unit 10 issues a state information report command to the IDP0 every second predetermined interval (1 minute with the present example). That is to say, in the event that an increase tendency of IDPs 170 is predicted, the operating state information of all IDPs 170 is collected at 1-minute intervals until the number of physical drives reaches two, which is the first threshold value serving as the lower limit value of the IDP increase change value when the number of IDPs 170 is one (1-unit configuration).

The control unit 13 reads out the number of physical drives being used at the current point-in-time from the physical drive usage prediction information 17, for example. The control unit 13 compares this value of physical drives in use with the first threshold value of the IDP increase configuration changing threshold (2) in the event that the number of IDPs 170 read out from the IDP configuration changing threshold value information 18 is one. That is to say, confirmation is made regarding whether or not the number of physical drives in use is one or more (step F50).

In the event that the number of physical drives in use is less than one (see the NO route in step F50), next, confirmation is made regarding whether or not the amount of time elapsed after the collecting unit 10 has issued in step A10 in FIG. 9 has reached the pre-stipulated timeout determination time, thereby determining whether a timeout has occurred (step F60). In the event that the amount of time elapsed after the collecting unit 10 has issued has reached the pre-stipulated timeout determination time, meaning that a timeout has occurred (see the YES route in step F60), the flow transitions to the processing of steps A170 or A10 in FIG. 9. On the other hand, in the event that this is not a timeout (see the NO route in step F60), the flow returns to step F40.

Also, in the event that the number of physical drives in use is one or more (see the YES route in step F50), the control unit 13 gives a power-on instruction for the IDP1, PDV2, and PDV3 to the PDU 132 (step F70). The control unit 13 stands by until PDV2 and PDV3 are in an ONLINE state (step F80).

Upon PDV2 and PDV3 being in an ONLINE state (see the YES route in step F80), the control unit 13 issues a sleep instruction to the IDP1 (step F90). The collecting unit 10 issues a state information report command to the IDP0 at the third predetermined interval (1-second intervals with this example) (step F100).

The control unit 13 reads out the number of physical drives in use at the current point-in-time, from the physical drive usage prediction information 17, for example. The control unit 13 compares this value of the number of units in use with the second threshold value of the IDP increase configuration changing threshold value (2) in the event that the number of IDPs 170 is one, read out from the IDP configuration changing threshold value information 18. That is to say, confirmation is made regarding whether or not the number of physical drives in use is two or more (step F110).

In the event that the number of physical drives in use is two or more (see the YES route in step F110), a wakeup command is issued to the IDP1 (step F180), and the IDP1 is placed in a running state. That is to say, the configuration of IDPs 170 is changed to a 2-unit configuration. Subsequently, the flow transitions to the processing of steps A170 or A10 in FIG. 9.

On the other hand, in the event that the number of physical drives in use is less than two (see the NO route in step F110), confirmation is made regarding whether or not the time elapsed since the collecting unit 10 has issued the state information report command in step A10 in FIG. 9 has reached the pre-stipulated timeout determination time, thereby determining whether or not a timeout has occurred (step F120).

In the event that the timeout determination time has elapsed after the collecting unit 10 has issued the state information report command, i.e., in the event that a timeout has occurred (see the YES route in step F120), the flow transitions to step F180.

Also, in the event that a timeout has not occurred (see the NO route in step F120), the control unit 13 confirms whether or not the number of physical drives in use at the current point-in-time is smaller than the value of the first threshold value (1) of the IDP increase configuration changing threshold value in the event that the number of IDPs 170 is one, read out from the IDP configuration changing threshold value information 18. That is to say, determination is made regarding whether or not the number of physical drives in use is zero (step F130).

In the event that the number of physical drives in use is one or more (see the NO route in step F130), the flow returns to step F100. On the other hand, in the event that the number of physical drives in use is zero (see the YES route in step F130), the operation state monitoring being performed as to the IDP 170, i.e., issuing of the state information report command at 1-second intervals, is stopped. The IDP1 is then stopped and the configuration is changed to a 1-unit configuration of the IDP0. That is to say, after a wakeup command is issued to the IDP1 (step F140), an operation stop instruction is issued to the IDP1 (step F150).

The control unit 13 stands by until PDV2 and PDV3 are in an OFFLINE state (step F160).

Upon both PDV2 and PDV3 being in an OFFLINE state (see the YES route in step F160), in step F170 the control unit 13 turns the electric power to the IDP1, PDV2, and PDV3 off (POWER OFF). Subsequently, the flow transitions to the processing of steps A170 or A10 in FIG. 9.

Thus, in the event that the number of physical drives does not reach one, which is the first threshold value of the IDP increase configuration changing threshold value for one IDP 170, despite the IDP increase prediction made by the number of processing units predicting unit 12, the number of IDPs 170 is not increased.

Also, in the event that the number of IDPs 170 currently running is not one (see the NO route in step F30), next, in step F190 in FIG. 19, confirmation is made regarding whether or not the current number of IDPs 170 running is two.

In the event that the number of IDPs 170 currently running is two (see the YES route in step F190), the collecting unit 10 issues a state information report command to the IDP0 and IDP1 every second predetermined interval (1 minute with the present example) (step F200). That is to say, in the event that an increase tendency of IDPs 170 is predicted, the operating state information of all IDPs 170 is collected at 1-minute intervals until the number of physical drives reaches three, which is the first threshold value serving as the lower limit value of the IDP increase change value when the number of IDPs 170 is two (2-unit configuration).

The control unit 13 reads out the number of physical drives being used at the current point-in-time from the physical drive usage prediction information 17, for example. The control unit 13 compares this value of physical drives in use with the first threshold value of the IDP increase configuration changing threshold (3) in the event that the number of IDPs 170 read out from the IDP configuration changing threshold value information 18 is two. That is to say, confirmation is made regarding whether or not the number of physical drives in use is three or more (step F210).

In the event that the number of physical drives in use is less than three (see the NO route in step F210), the value of the number of physical drives in use is compared with the first threshold value (1) of the IDP decrease configuration changing value when the number of IDPs 170 is two, read out from the IDP configuration changing threshold value information 18. That is to say, confirmation is made regarding whether or not the number of physical drives in use is one or less (step F220). In the event that the number of physical drives in use is one or less (see the YES route in step F220), the number of IDPs 170 in demand is one, so 1 is set to the second decrease flag (step F240). Subsequently, the flow transitions to the processing of steps A170 or A10 in FIG. 9.

Also, in the event that the number of physical drives in use is two or more (see the NO route in step F220), next, confirmation is made regarding whether or not the amount of time elapsed after the collecting unit 10 has issued in step A10 in FIG. 9 has reached the pre-stipulated timeout determination time, thereby determining whether a timeout has occurred (step F230). In the event that the amount of time elapsed after the collecting unit 10 has issued has reached the pre-stipulated timeout determination time, meaning that a timeout has occurred (see the YES route in step F230), the flow transitions to the processing of steps A170 or A10 in FIG. 9. On the other hand, in the event that this is not a timeout (see the NO route in step F60), the flow returns to step F200.

Also, in the event that the number of physical drives in use is three or more (see the YES route in step F210), the control unit 13 gives a power-on instruction for the IDP2, PDV4, and PDV5 to the PDU 132 (step F250). The control unit 13 stands by until PDV4 and PDV5 are in an ONLINE state (step F260).

Upon PDV4 and PDV5 being in an ONLINE state (see the YES route in step F260), the control unit 13 issues a sleep instruction to the IDP2 (step F270). The collecting unit 10 issues a state information report command to the IDP0 and IDP1 at the third predetermined interval (1-second intervals with this example) (step F280).

The control unit 13 reads out the number of physical drives in use at the current point-in-time, from the physical drive usage prediction information 17, for example. The control unit 13 compares this value of the number of units in use with the second threshold value of the IDP increase configuration changing threshold value (4) in the event that the number of IDPs 170 is two, read out from the IDP configuration changing threshold value information 18. That is to say, confirmation is made regarding whether or not the number of physical drives in use is four or more (step F290).

In the event that the number of physical drives in use is four or more (see the YES route in step F290), a wakeup command is issued to the IDP2 (step F360), and the IDP2 is placed in a running state. That is to say, the configuration of IDPs 170 is changed to a 3-unit configuration. Subsequently, the flow transitions to the processing of steps A170 or A10 in FIG. 9.

On the other hand, in the event that the number of physical drives in use is less than four (see the NO route in step F290), confirmation is made regarding whether or not the time elapsed since the collecting unit 10 has issued the state information report command in step A10 in FIG. 9 has reached the pre-stipulated timeout determination time, thereby determining whether or not a timeout has occurred (step F300).

In the event that the timeout determination time has elapsed after the collecting unit 10 has issued the state information report command, i.e., in the event that a timeout has occurred (see the YES route in step F300), the flow transitions to step F360.

Also, in the event that a timeout has not occurred (see the NO route in step F300), the control unit 13 confirms whether or not the number of physical drives in use at the current point-in-time is smaller than the value of the first threshold value (3) of the IDP increase configuration changing threshold value in the event that the number of IDPs 170 is two, read out from the IDP configuration changing threshold value information 18. That is to say, determination is made regarding whether or not the number of physical drives in use is two or less (step F310).

In the event that the number of physical drives in use is three or more (see the NO route in step F310), the flow returns to step F280. On the other hand, in the event that the number of physical drives in use is two or less (see the YES route in step F310), the operation state monitoring being performed as to the IDP 170, i.e., issuing of the state information report command at 1-second intervals, is stopped. The IDP2 is then stopped and the configuration is changed to a 2-unit configuration of the IDP0 and IDP1. That is to say, after a wakeup command is issued to the IDP2 (step F320), an operation stop instruction is issued to the IDP2 (step F330).

The control unit 13 stands by until PDV4 and PDV5 are in an OFFLINE state (step F340).

Upon both PDV4 and PDV5 being in an OFFLINE state (see the YES route in step F340), in step F350 the control unit 13 turns the electric power to the IDP2, PDV4, and PDV5 off (POWER OFF). Subsequently, the flow transitions to the processing of steps A170 or A10 in FIG. 9.

Thus, in the event that the number of physical drives does not reach three, which is the first threshold value of the IDP increase configuration changing threshold value for two IDPs 170, despite the IDP increase prediction made by the number of processing units predicting unit 12, the number of IDPs 170 is not increased.

Also, in the event that the number of physical drives is one or less, which is the first threshold value of the IDP decrease configuration changing threshold value for two IDPs 170, 1 is set to the first decrease flag to decrease the number of IDPs 170.

Also, in the event that the number of IDPs 170 currently running is not two (see the NO route in step F190), next, in step F370 in FIG. 20, confirmation is made regarding whether or not the current number of IDPs 170 running is three.

In the event that the number of IDPs 170 currently running is three (see the YES route in step F370), the collecting unit 10 issues a state information report command to IDP0 through IDP3 every second predetermined interval (1 minute with the present example) (step F380). That is to say, in the event that an increase tendency of IDPs 170 is predicted, the operating state information of all IDPs 170 is collected at 1-minute intervals until the number of physical drives reaches four, which is the first threshold value serving as the lower limit value of the IDP increase change value when the number of IDPs 170 is three (3-unit configuration).

The control unit 13 reads out the number of physical drives being used at the current point-in-time from the physical drive usage prediction information 17, for example. The control unit 13 compares this value of physical drives in use with the first threshold value of the IDP increase configuration changing threshold (5) in the event that the number of IDPs 170 read out from the IDP configuration changing threshold value information 18 is three. That is to say, confirmation is made regarding whether or not the number of physical drives in use is five or more (step F390).

In the event that the number of physical drives in use is less than five (see the NO route in step F390), the value of the number of physical drives in use is compared with the first threshold value (3) of the IDP decrease configuration changing value when the number of IDPs 170 is three, read out from the IDP configuration changing threshold value information 18. That is to say, confirmation is made regarding whether or not the number of physical drives in use is three or less (step F400). In the event that the number of physical drives in use is three or less (see the YES route in step F400), the number of IDPs 170 in demand is two or less, so 1 is set to the second decrease flag (step F420). Subsequently, the flow transitions to the processing of steps A170 or A10 in FIG. 9.

Also, in the event that the number of physical drives in use is four or more (see the NO route in step F400), next, confirmation is made regarding whether or not the amount of time elapsed after the collecting unit 10 has issued in step A10 in FIG. 9 has reached the pre-stipulated timeout determination time, thereby determining whether a timeout has occurred (step F410). In the event that the amount of time elapsed after the collecting unit 10 has issued has reached the pre-stipulated timeout determination time, meaning that a timeout has occurred (see the YES route in step F410), the flow transitions to the processing of steps A170 or A10 in FIG. 9. On the other hand, in the event that this is not a timeout (see the NO route in step F410), the flow returns to step F380.

Also, in the event that the number of physical drives in use is five or more (see the YES route in step F390), the control unit 13 gives a power-on instruction for the IDP3, PDV6, and PDV7 to the PDU 132 (step F430). The control unit 13 stands by until PDV6 and PDV7 are in an ONLINE state (step F440).

Upon PDV6 and PDV7 being in an ONLINE state (see the YES route in step F440), the control unit 13 issues a sleep instruction to the IDP3 (step F450). The collecting unit 10 issues a state information report command to the IDP0 through IDP2 at the third predetermined interval (1-second intervals with this example) (step F460).

The control unit 13 reads out the number of physical drives in use at the current point-in-time, from the physical drive usage prediction information 17, for example. The control unit 13 compares this value of the number of units in use with the second threshold value of the IDP increase configuration changing threshold value (6) in the event that the number of IDPs 170 is three, read out from the IDP configuration changing threshold value information 18. That is to say, confirmation is made regarding whether or not the number of physical drives in use is six or more (step F470).

In the event that the number of physical drives in use is six or more (see the YES route in step F470), a wakeup command is issued to the IDP3 (step F540), and the IDP3 is placed in a running state. That is to say, the configuration of IDPs 170 is changed to a 4-unit configuration. Subsequently, the flow transitions to the processing of steps A170 or A10 in FIG. 9.

On the other hand, in the event that the number of physical drives in use is less than six (see the NO route in step F470), confirmation is made regarding whether or not the time elapsed since the collecting unit 10 has issued the state information report command in step A10 in FIG. 9 has reached the pre-stipulated timeout determination time, thereby determining whether or not a timeout has occurred (step F480).

In the event that the timeout determination time has elapsed after the collecting unit 10 has issued the state information report command, i.e., in the event that a timeout has occurred (see the YES route in step F480), the flow transitions to step F540.

Also, in the event that a timeout has not occurred (see the NO route in step F480), the control unit 13 confirms whether or not the number of physical drives in use at the current point-in-time is smaller than the value of the first threshold value (5) of the IDP increase configuration changing threshold value in the event that the number of IDPs 170 is three, read out from the IDP configuration changing threshold value information 18. That is to say, determination is made regarding whether or not the number of physical drives in use is four or less (step F490).

In the event that the number of physical drives in use is five or more (see the NO route in step F490), the flow returns to step F460. On the other hand, in the event that the number of physical drives in use is three or less (see the YES route in step F490), the operation state monitoring being performed as to the IDP 170, i.e., issuing of the state information report command at 1-second intervals, is stopped. The IDP3 is then stopped and the configuration is changed to a 3-unit configuration of the IDP0 through IDP2. That is to say, after a wakeup command is issued to the IDP3 (step F500), an operation stop instruction is issued to the IDP3 (step F510). The control unit 13 stands by until PDV6 and PDV7 are in an ONLINE state (step F520).

Upon both PDV6 and PDV7 being in an ONLINE state (see the YES route in step F520), in step F530 the control unit 13 turns the electric power to the IDP3, PDV6, and PDV7 off (POWER OFF). Subsequently, the flow transitions to the processing of steps A170 or A10 in FIG. 9.

Also, in the event that the number of IDPs 170 currently running is not three (see the NO route in step F370), the flow transitions to the processing of steps A170 or A10 in FIG. 9.

Thus, in the event that the number of physical drives does not reach five, which is the first threshold value of the IDP increase configuration changing threshold value for three IDPs 170, despite the IDP increase prediction made by the number of processing units predicting unit 12, the number of IDPs 170 is not increased.

Also, in the event that the number of physical drives is three or less, which is the first threshold value of the IDP decrease configuration changing threshold value for three IDPs 170, 1 is set to the second decrease flag to decrease the number of IDPs 170.

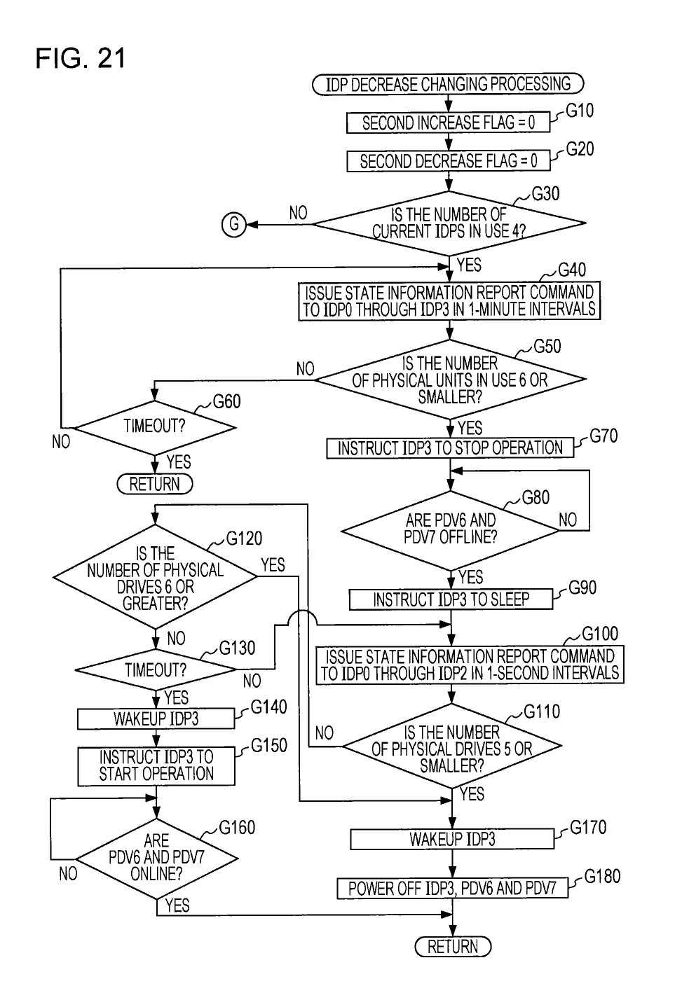

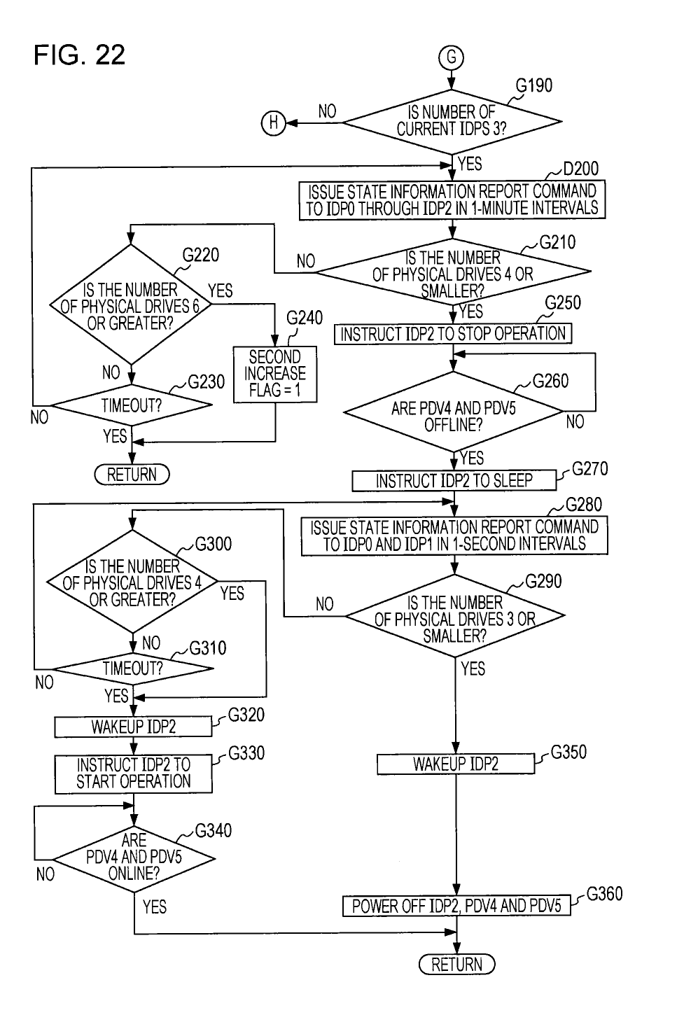

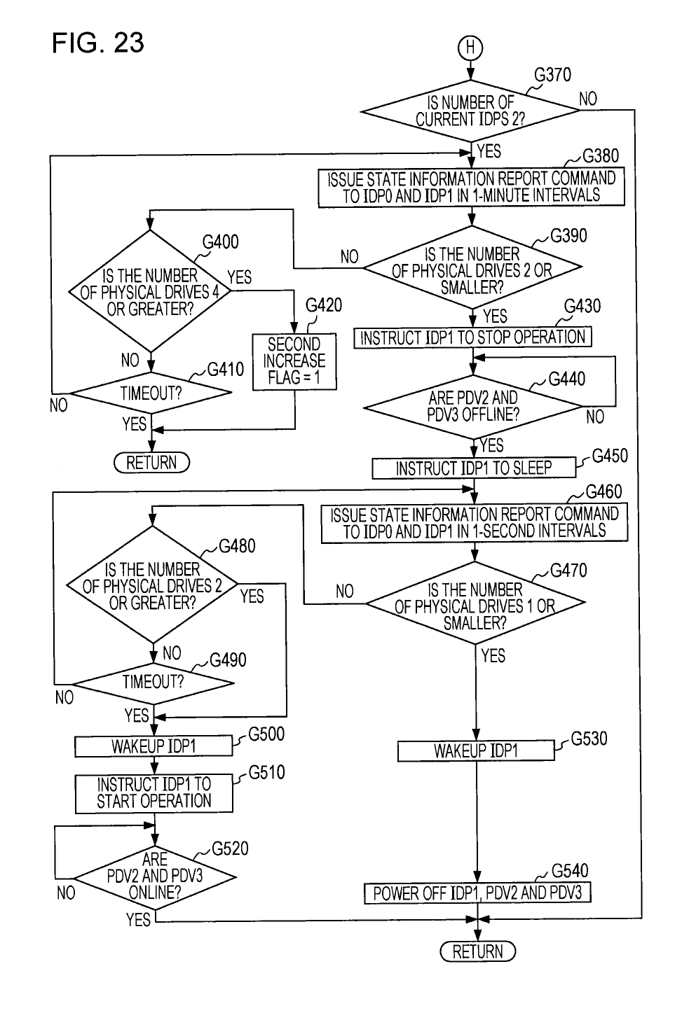

Next, the IDP decrease change processing technique (see steps A180 and A190 in FIG. 9) with the virtual tape system 1 as an example of the embodiment will be described following the method illustrated in FIGS. 21 through 23 (steps G10 through G540). Steps G10 through G180 are illustrated in FIG. 21, steps G190 through G360 are illustrated in FIG. 22, and steps G370 through G540 are illustrated in FIG. 23. Note that with this example, the number of processing units predicting unit 12 performs increase/decrease prediction determination of the IDPs 170 based on the IDP configuration changing threshold value information 18 exemplarily illustrated in FIG. 8.

First, after having initialized the first increase flag and first decrease flag by setting each to 0 (steps G10 and G20), the control unit 13 references the physical drive usage prediction information 17 for example, thereby confirming whether or not the number of IDPs 170 currently running is four (step G30).

In the event that the number of IDPs 170 currently running is four (see the YES route in step G30), the collecting unit 10 issues a state information report command to the IDP0 through IDP3 every second predetermined interval (1 minute with the present example) (step G40).

The control unit 13 reads out the number of physical drives being used at the current point-in-time from the physical drive usage prediction information 17, for example. The control unit 13 compares this value of physical drives in use with the first threshold value of the IDP decrease configuration changing threshold (5) in the event that the number of IDPs 170 read out from the IDP configuration changing threshold value information 18 is four. That is to say, confirmation is made regarding whether or not the number of physical drives in use is five or less (step G50).

In the event that the number of physical drives in use is seven or more (see the NO route in step G50), next, confirmation is made regarding whether or not the amount of time elapsed after the collecting unit 10 has issued in step A10 in FIG. 9 has reached the pre-stipulated timeout determination time, thereby determining whether a timeout has occurred (step G60). In the event that the amount of time elapsed after the collecting unit 10 has issued has reached the pre-stipulated timeout determination time, meaning that a timeout has occurred (see the YES route in step G60), the flow transitions to the processing of step A10 in FIG. 9. On the other hand, in the event that this is not a timeout (see the NO route in step G60), the flow returns to step G40.

Also, in the event that the number of physical drives in use is six or less (see the YES route in step G50), the control unit 13 gives an operation stop instruction for the IDP3 to the PDU 132 (step G70).

Upon receiving the operation stop instruction, the IDP 170 immediately sets NOT READY logical drives to OFFLINE. Also, READY logical drives continue to operate in a READY state until an unload command is received from the host device 200, and go OFFLINE at the point that the unload command is received. After having configured that all logical drives on the IDP (two with the embodiment) have gone OFFLINE, the PCU 120 is notified that operations of the IDP 170 have stopped.

The control unit 13 stands by until all logical drives of the IDP3 are in an OFFLINE state (step G80).

Upon all logical drives of the IDP3 being in an OFFLINE state (see the YES route in step G80), the control unit 13 issues a sleep instruction to the IDP3 (step G90). The collecting unit 10 issues a state information report command to the IDP0 through IDP2 at the third predetermined interval (1-second intervals with this example) (step G100).

The control unit 13 reads out the number of physical drives in use at the current point-in-time, from the physical drive usage prediction information 17, for example. The control unit 13 compares this value of the number of units in use with the first threshold value of the IDP decrease configuration changing threshold value (5, which is the lower limit value) in the event that the number of IDPs 170 is four, read out from the IDP configuration changing threshold value information 18. That is to say, confirmation is made regarding whether or not the number of physical drives in use is five or less (step G110).

In the event that the number of physical drives in use is five or less (see the YES route in step G110), a wakeup command is issued to the IDP3 (step G170), and the IDP3, PDV6, and PDV7 are powered off (POWER OFF) (step G180). That is to say, the configuration of IDPs 170 is changed to a 3-unit configuration. Subsequently, the flow transitions to the processing of step A10 in FIG. 9.

On the other hand, in the event that the number of physical drives in use is six or more (see the NO route in step G110), the control unit 13 next compares the number of physical drives in use at the current point-in-time with the value of the second threshold value (6, which is the upper limit value) of the IDP decrease configuration changing threshold value in the event that the number of IDPs 170 is four, read out from the IDP configuration changing threshold value information 18. That is to say, determination is made regarding whether or not the number of physical drives in use is six or more (step G120).

In the event that the number of physical drives in use is five or less(see the NO route in step G120), confirmation is made regarding whether or not the time elapsed since the collecting unit 10 has issued the state information report command in step A10 in FIG. 9 has reached the pre-stipulated timeout determination time, thereby determining whether or not a timeout has occurred (step G130).

In the event that the timeout determination time has elapsed after the collecting unit 10 has issued the state information report command, i.e., in the event that a timeout has occurred (see the YES route in step G130), a wakeup command is issued to the IDP3 (step G140), after which an operation stop instruction is issued to the IDP3 (step G150). The control unit 13 stands by until PDV6 and PDV7 are in an ONLINE state (step G160).

Upon PDV6 and PDV7 being in an ONLINE state, and the configuration returns to the original 4-unit configuration of IDPs 170 (see the YES route in step G160), the flow then transitions to the processing of step A10 in FIG. 9.

In the event that the number of physical drives in use is six or more (see the YES route in step G120), the flow advances to step G170.

Also, in the event that a timeout has not occurred in G130 (see the NO route in step G130), the flow transitions to step G100.

Thus, in the event that the number of physical drives does not decrease to five or lower, which is the first threshold value of the IDP decrease configuration changing threshold value for four IDPs 170, despite the IDP decrease prediction made by the number of processing units predicting unit 12, the number of IDPs 170 is not decreased.

Also, in the event that the number of IDPs 170 currently running is not four (see the NO route in step G30), next, in step G190 in FIG. 22, confirmation is made regarding whether or not the current number of IDPs 170 running is three.

In the event that the number of IDPs 170 currently running is three (see the YES route in step G190), the collecting unit 10 issues a state information report command to the IDP0 through IDP2 every second predetermined interval (1 minute with the present example) (step G200).

The control unit 13 reads out the number of physical drives being used at the current point-in-time from the physical drive usage prediction information 17, for example. The control unit 13 compares this value of physical drives in use with the first threshold value (upper limit value) of the IDP decrease configuration changing threshold (4) in the event that the number of IDPs 170 read out from the IDP configuration changing threshold value information 18 is three. That is to say, confirmation is made regarding whether or not the number of physical drives in use is four or less (step G210).

In the event that the number of physical drives in use is five or more (see the NO route in step G210), the value of the number of physical drives in use is compared with the second threshold value (6) of the IDP increase configuration changing value when the number of IDPs 170 is three, read out from the IDP configuration changing threshold value information 18. That is to say, confirmation is made regarding whether or not the number of physical drives in use is six or more (step G220). In the event that the number of physical drives in use is six or more (see the YES route in step G220), the number of IDPs 170 in demand is four, so 1 is set to the second increase flag (step G240). Thus, in the event that the number of physical drives reaches six, which is the second threshold value of the IDP increase configuration changing threshold value for three IDPs 170, despite the prediction made by the number of processing units predicting unit 12, the number of IDPs 170 is increased. Subsequently, the flow transitions to the processing of step A10 in FIG. 9.

Also, in the event that the number of physical drives in use is less than six (see the NO route in step G220), next, confirmation is made regarding whether or not the amount of time elapsed after the collecting unit 10 has issued in step A10 in FIG. 9 has reached the pre-stipulated timeout determination time, thereby determining whether a timeout has occurred (step G230). In the event that the amount of time elapsed after the collecting unit 10 has issued has reached the pre-stipulated timeout determination time, meaning that a timeout has occurred (see the YES route in step G230), the flow transitions to the processing of step A10 in FIG. 9. On the other hand, in the event that this is not a timeout (see the NO route in step G230), the flow returns to step G200.

Also, in the event that the number of physical drives in use is four or less (see the YES route in step G210), the control unit 13 gives an operation stop instruction for the IDP2 to the PDU 132 (step G250). The control unit 13 stands by until all physical drives of the IDP2 are in an OFFLINE state (step G260).

Upon all logical drives of the IDP2 being in an OFFLINE state (see the YES route in step G260), the control unit 13 issues a sleep instruction to the IDP2 (step G270). The collecting unit 10 issues a state information report command to the IDP0 and IDP1 at the third predetermined interval (1-second intervals with this example) (step D280).

The control unit 13 reads out the number of physical drives in use at the current point-in-time, from the physical drive usage prediction information 17, for example. The control unit 13 compares this value of the number of units in use with the first threshold value of the IDP decrease configuration changing threshold value (3) in the event that the number of IDPs 170 is three, read out from the IDP configuration changing threshold value information 18. That is to say, confirmation is made regarding whether or not the number of physical drives in use is three or less (step G290).

In the event that the number of physical drives in use is three or less (see the YES route in step G290), a wakeup command is issued to the IDP2 (step G350), and the IDP2, PDV4 and PDV5 are powered off (POWER OFF) (step G360). That is to say, the configuration of IDPs 170 is changed to a 2-unit configuration. Subsequently, the flow transitions to the processing of step A10 in FIG. 9.

On the other hand, in the event that the number of physical drives in use is four or more (see the NO route in step G290), the control unit 13 next compares the number of physical drives in use at the current point-in-time with the value of the second threshold value (4, which is the upper limit value) of the IDP decrease configuration changing threshold value in the event that the number of IDPs 170 is three, read out from the IDP configuration changing threshold value information 18. That is to say, determination is made regarding whether or not the number of physical drives in use is four or more (step G300).

In the event that the number of physical drives in use is four or less (see the NO route in step G300), confirmation is made regarding whether or not the time elapsed since the collecting unit 10 has issued the state information report command in step A10 in FIG. 9 has reached the pre-stipulated timeout determination time, thereby determining whether or not a timeout has occurred (step G310).

In the event that the timeout determination time has elapsed after the collecting unit 10 has issued the state information report command, i.e., in the event that a timeout has occurred (see the YES route in step G310), a wakeup command is issued to the IDP2 (step G320), and an operation start instruction is issued for the IDP2 (step G330).

The control unit 13 stands by until all physical drives of the IDP3 are in an ONLINE state (step G340).

Upon both PDV4 and PDV5 being in an ONLINE state, and the configuration returns to the original 3-unit configuration of IDPs 170 (see the YES route in step G340), the flow then transitions to the processing of step A10 in FIG. 9.

Also, in the event that a timeout has not occurred (see the NO route in step G310), the flow transitions to step G280.

Further, in the event that the number of physical drives in use is four or more (see the YES route in step G300), the flow transitions to step G320.

Thus, in the event that the number of physical drives is not three or less, which is the first threshold value of the IDP decrease configuration changing threshold value for three IDPs 170, despite the increase prediction made by the number of processing units predicting unit 12, the number of IDPs 170 is not decreased.

Also, in the event that the number of physical drives is six or more, which is the second threshold value of the IDP decrease configuration changing threshold value for three IDPs 170, 1 is set to the second increase flag to increase the number of IDPs 170.

Also, in the event that the number of IDPs 170 currently running is not three (see the NO route in step G190), next, in step G370 in FIG. 23, confirmation is made regarding whether or not the current number of IDPs 170 running is two.

In the event that the number of IDPs 170 currently running is two (see the YES route in step G370), the collecting unit 10 issues a state information report command to IDP0 and IDP1 every second predetermined interval (1 minute with the present example) (step G380).

The control unit 13 reads out the number of physical drives being used at the current point-in-time from the physical drive usage prediction information 17, for example. The control unit 13 compares this value of physical drives in use with the second threshold value of the IDP decrease configuration changing threshold (5) in the event that the number of IDPs 170 read out from the IDP configuration changing threshold value information 18 is three. That is to say, confirmation is made regarding whether or not the number of physical drives in use is two or less (step G390).

In the event that the number of physical drives in use is three or more (see the NO route in step G390), the value of the number of physical drives in use is compared with the second threshold value (4) of the IDP increase configuration changing value when the number of IDPs 170 is two, read out from the IDP configuration changing threshold value information 18. That is to say, confirmation is made regarding whether or not the number of physical drives in use is three or less (step G400). In the event that the number of physical drives in use is four or more (see the YES route in step G400), the number of IDPs 170 in demand is three or less, so 1 is set to the second decrease flag (step G420). That is to say, in the event that the number of physical devices in use is four or more which is the second threshold value of the IDP increase configuration changing value in the event that the number of IDPs 170 is two, the number of IDPs 170 is increased. Subsequently, the flow transitions to the processing of step A10 in FIG. 9.

Also, in the event that the number of physical drives in use is four or less (see the NO route in step G400), next, confirmation is made regarding whether or not the amount of time elapsed after the collecting unit 10 has issued in step A10 in FIG. 9 has reached the pre-stipulated timeout determination time, thereby determining whether a timeout has occurred (step G410). In the event that the amount of time elapsed after the collecting unit 10 has issued has reached the pre-stipulated timeout determination time, meaning that a timeout has occurred (see the YES route in step G410), the flow transitions to the processing of step A10 in FIG. 9. On the other hand, in the event that this is not a timeout (see the NO route in step G410), the flow returns to step G380.

Also, in the event that the number of physical drives in use is two or less (see the YES route in step G390), the control unit 13 gives an operation stop instruction for the IDP1 to the PDU 132 (step G430). The control unit 13 stands by until PDV2 and PDV3 are both in an OFFLINE state (step G440).

Upon PDV2 and PDV3 both being in an OFFLINE state (see the YES route in step G440), the control unit 13 issues a sleep instruction to the IDP1 (step G450). The collecting unit 10 issues a state information report command to the IDP0 at the third predetermined interval (1-second intervals with this example) (step D460).

The control unit 13 reads out the number of physical drives in use at the current point-in-time, from the physical drive usage prediction information 17, for example. The control unit 13 compares this value of the number of units in use with the first threshold value of the IDP decrease configuration changing threshold value (1) in the event that the number of IDPs 170 is two, read out from the IDP configuration changing threshold value information 18. That is to say, confirmation is made regarding whether or not the number of physical drives in use is one or less (step G470).

In the event that the number of physical drives in use is one or less (see the YES route in step G470), a wakeup command is issued to the IDP1 (step G530), and the IDP1, PDV2 and PDV3 are powered off (POWER OFF) (step G540). That is to say, the configuration of IDPs 170 is changed to a 1-unit configuration. Subsequently, the flow transitions to the processing of step A10 in FIG. 9.

On the other hand, in the event that the number of physical drives in use is two or greater (see the NO route in step G470), the control unit 13 next compares the number of physical drives in use at the current point-in-time with the value of the second threshold value (2, which is the upper limit value) of the IDP decrease configuration changing threshold value in the event that the number of IDPs 170 is two, read out from the IDP configuration changing threshold value information 18. That is to say, confirmation is made regarding whether or not the number of physical drives in use is two or more (step G480).

In the event that the number of physical drives in use is less than two (see the NO route in step G480), confirmation is made regarding whether or not the time elapsed since the collecting unit 10 has issued the state information report command in step A10 in FIG. 9 has reached the pre-stipulated timeout determination time, thereby determining whether or not a timeout has occurred (step G490).

In the event that the timeout determination time has elapsed after the collecting unit 10 has issued the state information report command, i.e., in the event that a timeout has occurred (see the YES route in step G490), the control unit 13 issues a wakeup command to the IDP1 (step G500), and issues an operation start instruction for the IDP1 (step G510). The control unit 13 stands by until both PDV2 and PDV3 are in an ONLINE state (step G520).

Upon PDV2 and PDV3 both being in an ONLINE state, and the configuration returns to the original 2-unit configuration of IDPs 170 (see the YES route in step G520), the flow then transitions to the processing of step A10 in FIG. 9.

Also, in the event that a timeout has not occurred (see the NO route in step G490 in step 490), the flow transitions to step G460.

Further, in the event that the number of physical drives in use is two or greater in step G480 (see the YES route in step G480), the flow advances to step G500.

Also, in the event that the number of IDPs 170 currently running is not two (see the NO route in step G370), the flow transitions to the processing of step A10 in FIG. 9.

Thus, in the event that the number of physical drives is not one or less, which is the first threshold value of the IDP decrease configuration changing threshold value for two IDPs 170, by the next monitoring time, despite the IDP increase prediction made by the number of processing units predicting unit 12, the number of IDPs 170 is not decreased.

Also, in the event that the number of physical drives is four or more, which is the second threshold value of the IDP increase configuration changing threshold value for two IDPs 170, 1 is set to the second increase flag to increase the number of IDPs 170.

Thus, with the virtual tape system 1 as an example of the embodiment, just as many ICPs 150 as in demand are operated in accordance with the usage state of logical drives, and unnecessary ICPs 150 can be stopped readily. Accordingly, electric power consumption can be reduced, facilitating efficient operation.

Also, just as many IDPs 170 as in demand are operated in accordance with the usage state of tape drive 310, and unnecessary IDPs 170 can be stopped readily. This also allows electric power consumption to be reduced, facilitating efficient operation.

Further, usage prediction of the logical drives and physical drives is performed by the number of processing units predicting unit 12 based on state information which is past operation history, stored in a storage device. Accordingly, usage prediction can be performed in accordance with the usage operation history of the virtual tape system 1, so reliability of prediction can be improved.

The disclosed technology is not restricted to the above embodiment, and various modifications can be made without departing from the essence of the embodiment. Components and processes of the embodiment can be optionally selected or combined as appropriate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A library device having a plurality of processing units that control data access to one or more drive units, the library device comprising:
a processor; and
a memory coupled to the processor, wherein the processor executes a process includes:
collecting state information of each drive unit processed in each of the processing units;
predicting a number of drive units in use a certain amount of time later, based on the state information of each drive unit in the processing units collected by the collecting;
predicting a number of the processing units in demand a certain amount of time later, based on restricting information indicating the number of the drive units to be controlled by the processing and the number of the drive units that has been predicted; and
controlling supply of electric power to the processing units, based on the number of processing units in demand predicted by the predicting of the number of the processing units.

2. The library device according to claim 1, wherein the collecting collects, from the plurality of processing units, the number of drive units in use at the processing units as the state information.

3. The library device according to claim 1, wherein the collecting collects the state information from the processing units every certain time interval.

4. The library device according to claim 1, wherein the drive unit is a logical drive.

5. The library device according to claim 1, wherein the drive unit is a physical drive.

6. A method for controlling by a library device having a plurality of processing units that control data access to one or more drive units, the method comprising:
collecting, from the plurality of processing units, state information of the drive devices at the processing units;
predicting the number of drive devices in use a predetermined amount of time later, based on collected state information of the drive devices at the processing units;
predicting the number of the processing units in demand a predetermined amount of time later, based on number of devices restricting information representing the number of drive devices to be controlled by the processing units, and the number of devices that has been predicted; and
controlling supply of electric power to the processing units, based on the predicted number of processing units in demand.

7. The method according to claim 6, wherein the number of drive units in use at the processing units is collected from the plurality of processing units as the state information.

8. The method according to claim 6, wherein the state information is collected from the processing units every certain time interval.

9. The method according to claim 6, wherein the drive unit is a logical drive.

10. The method according to claim 6, wherein the drive unit is a physical drive.

11. A computer readable recording medium having stored therein a program for causing a computer to execute a process for controlling a library device, the process comprising:
collecting, from the plurality of processing units, state information of the drive devices at the processing units;
predicting the number of drive devices in use a predetermined amount of time later, based on collected state information of the drive devices at the processing units;
predicting the number of the processing units in demand a predetermined amount of time later, based on number of devices restricting information representing the number of drive devices to be controlled by the processing units, and the number of devices that has been predicted; and
controlling supply of electric power to the processing units, based on the predicted number of processing units in demand.
